(19) United States
(12) Patent Application Publication
(10) Pub. No.: US 2025/0203415 A1
(43) Pub. Date: Jun. 19, 2025

(54) WLAN SENSING PROCEDURES

(71) Applicant: INTERDIGITAL PATENT HOLDINGS, INC., Wilmington, DE (US)

(72) Inventors: Mahmoud Saad, Montreal (CA); Hanqing Lou, Syosset, NY (US); Zinan Lin, Basking Ridge, NJ (US); Satyanarayana Katla, London (GB); Rui Yang, Greenlawn, NY (US)

(73) Assignee: INTERDIGITAL PATENT HOLDINGS, INC., Wilmington, DE (US)

(21) Appl. No.: 18/851,244

(22) PCT Filed: Mar. 30, 2023
(86) PCT No.: PCT/US2023/016851

§ 371 Date: Sep. 26, 2024

Related U.S. Application Data
(60) Provisional application No. 63/326,032, filed on Mar. 31, 2022.
(60) Provisional application No. 63/343,806, filed on May 19, 2022.
(60) Provisional application No. 63/346,532, filed on May 27, 2022.

(51) Int. Cl. H04W 24/08; H04B 7/06; H04W 84/12

(52) U.S. Cl. CPC H04W 24/08; H04B 7/0626; H04W 84/12

(57) ABSTRACT

A method and station (STA) for WLAN sensing is disclosed. A STA may receive a trigger frame which may comprise at least a common information field that may comprise at least a trigger type subfield and a trigger dependent common information subfield. The trigger dependent common information subfield may comprise sensing subfields that are based on a value of the trigger type subfield. The STA may send a trigger response frame in a format that is at least based on at least one of the sensing subfields. The trigger frame may comprise a user information field which may comprise a trigger dependent user information subfield. The trigger dependent user information subfield may comprise at least a threshold value subfield and an indication of results collection subfield. Information in the trigger response frame may be at least based on the threshold value subfield and the indication of results collection subfield.

### CROSS-REFERENCE TO RELATED APPLICATIONS

This application claims the benefit of U.S. Provisional Application No. 63/326,032, filed Mar. 31, 2022, U.S. Provisional Application No. 63/343,806, filed May 19, 2022, and Provisional Application No. 63/346,532 filed May 27, 2022, the contents of each are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA.

### SUMMARY

A method and station (STA) for wireless local area network (WLAN) sensing is disclosed. A STA may receive a trigger frame. The trigger frame may comprise at least a common information field. The common information field may comprise a trigger type subfield. The common information field may comprise a trigger dependent common information subfield. The trigger dependent common information subfield may comprise sensing subfields. The sensing subfields may be based on a value of the trigger type subfield. The STA may send a trigger response frame. A format of the trigger response frame may be at least based on at least one of the sensing subfields of the trigger dependent common information subfield. The trigger frame may further comprise a user information field. The user information field may comprise a trigger dependent user information subfield. The trigger dependent user information subfield may comprise at least a threshold value subfield and an indication of results collection subfield. Information in the trigger response frame may be at least based on the threshold value subfield and the indication of results collection subfield. The trigger type subfield value may indicate a ranging trigger frame variant or a null data packet (NDP) sounding poll trigger frame variant. On a condition that the trigger type subfield value indicates a ranging trigger frame variant, the sensing subfields of the trigger dependent common information subfield may comprise at least one of: a sensing trigger subtype subfield, a measurement setup identification (MSI) subfield, a measurement instance identification (MII) subfield, or a session setup identification subfield. The sensing trigger subtype subfield may comprise information indicating a sensing trigger frame subvariant. The sensing trigger frame subvariant may comprise one of: poll, null data packet (NDP) soliciting, report, threshold based result collection, or group NDP soliciting.

On a condition that the trigger type subfield value indicates a NDP sounding poll trigger frame variant, the sensing subfields of the trigger dependent common information subfield may comprise at least one of: a NDP sensing/sounding subtype subfield, a number of extremely high throughput (EHT)—long training field (LTF) symbols extension subfield, a total number of spatial streams (NSS) subfield, a punctured channel information subfield, or an EHT-SIG disregard subfield. A reserved bit in the common information field may indicate that the trigger frame is for sensing. The transmitted trigger response frame may be a null data packet (NDP) physical layer protocol data unit (PPDU). The STA may receive an indication of a collaborative responder role. The indication of a collaborative responder role may be received in a sensing measurement parameters field.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of a Trigger Frame format;

FIG. 3 is an example of an EHT Variant User Info field format;

FIG. 4 is an example of an EHT Special User Info field format;

FIG. 5 is an example of a Common Info field;

FIG. 6 is an example of a Trigger Dependent Common Info subfield for a Ranging Trigger variant;

FIG. 7 is an example of a Trigger Dependent Common Info subfield of a Ranging Trigger frame of subvariant Passive TB Sounding;

FIG. 8 is an example of a User Info field for a Ranging Trigger frame of subvariant Poll and Report;

FIG. 9 is an example of a User Info field for Sounding subvariant;

FIG. 10 is an example of a User Info field for Securing Sounding subvariant;

FIG. 11 is an example of a HE/Ranging/EHT NDP Announcement frame format;

FIG. 12 is an example of a STA Info field format in an EHT NDP Announcement frame;

FIG. 13 is an example of a STA Info field format in a Ranging NDP Announcement frame when an AID11 subfield is less than 2008;

FIG. 14 is an example of a STA Info field format in a Ranging NDP Announcement frame if an AID11 subfield is 2043;

FIG. 15 is an example of a STA Info field format in a Ranging NDP Announcement frame if the AID11 subfield is 2044;

FIG. 16 is an example of a STA Info field format in a Ranging NDP Announcement frame if an AID11 subfield is 2045;

FIG. 17 is an example of an EHT Operation element;

FIG. 18 is an example of EHT Operation Information subfields;

FIG. 19 is an example of a system model for the non-orthogonal NDP transmission;

FIG. 20 is an example method for Non-Orthogonal Uplink Sensing;

FIG. 21 is an example of different long training field (LTF) repetitions for different sensing transmitters in UL sensing;

FIG. 22 is an example of overlapped uplink NDP transmission;

FIG. 23 is an example of non-orthogonal transmission with overlapped channels;

FIG. 24 shows an example trigger frame format for WLAN sensing;

FIG. 25 shows an example method for WLAN sensing;

FIG. 26 is an example method for WLAN sensing;

FIG. 27 is an example of a Trigger Dependent Common Info subfield for a Sensing Trigger variant;

FIG. 28 is an example of a User Info field for a Sensing Trigger frame of subvariant Poll or Report soliciting the response using HE PPDU;

FIG. 29 is an example of a User Info field for a Sensing Trigger frame of subvariant Poll or Report soliciting the response using EHT PPDU;

FIG. 30 is an example of a User Info field for a Sensing Trigger frame of subvariant NDP soliciting;

FIG. 31 is an example of a User Info field for a Sensing Trigger frame of subvariant Group NDP soliciting;

FIG. 32 is an example of a Trigger Dependent User Info subfield for a Sensing Trigger frame of subvariant Threshold based results collection;

FIG. 33 is an example of an EHT variant Common Info field in a Trigger frame;

FIG. 34 shows an example of Trigger Dependent Common Info subfields for an EHT variant Common Info filed in a trigger frame;

FIG. 35 is an example method of behavior of a responder participating in Collaborative Sensing;

FIG. 36 is an example of an Enhanced Sensing Measurement Setup Request frame Action field format with an Indication of Directional Multi-Gigabit (DMG) Sensing subfield;

FIG. 37 shows an example DMG Sensing Measurement Setup Request frame Action field format;

FIG. 38 shows an example Enhanced Sensing Measurement Setup Request frame Action field format;

FIG. 39 shows an example design of a Sensing Measurement Parameters field format;

FIG. 40 shows an example design of a Sensing Measurement Parameters field format; and

FIG. 41 shows an example design of the User Info field of the Sounding Subvariant of the Sensing Trigger frame.

### DETAILED DESCRIPTION

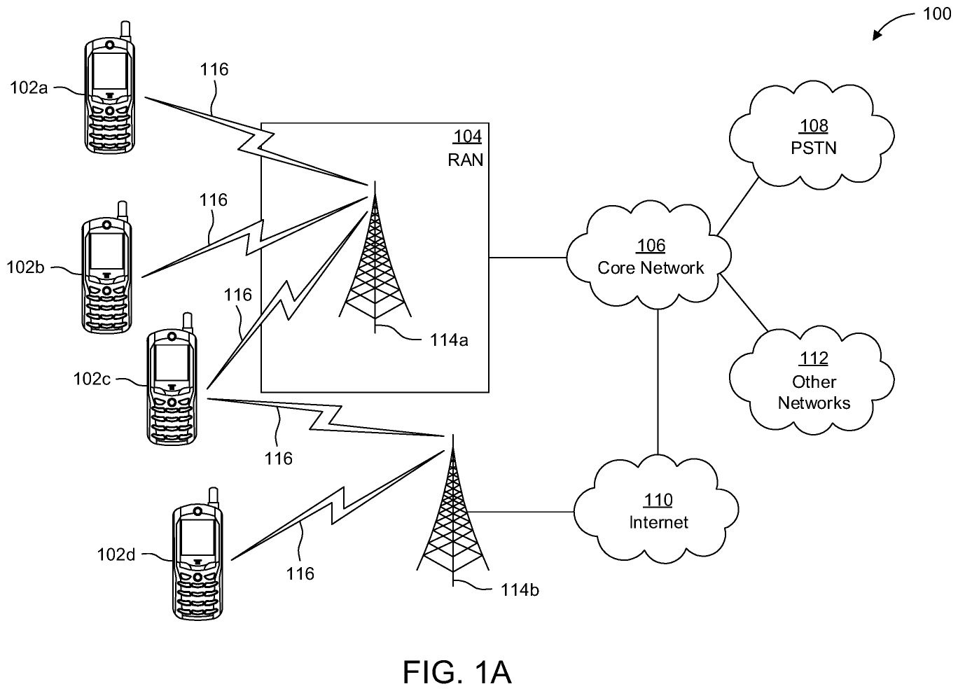

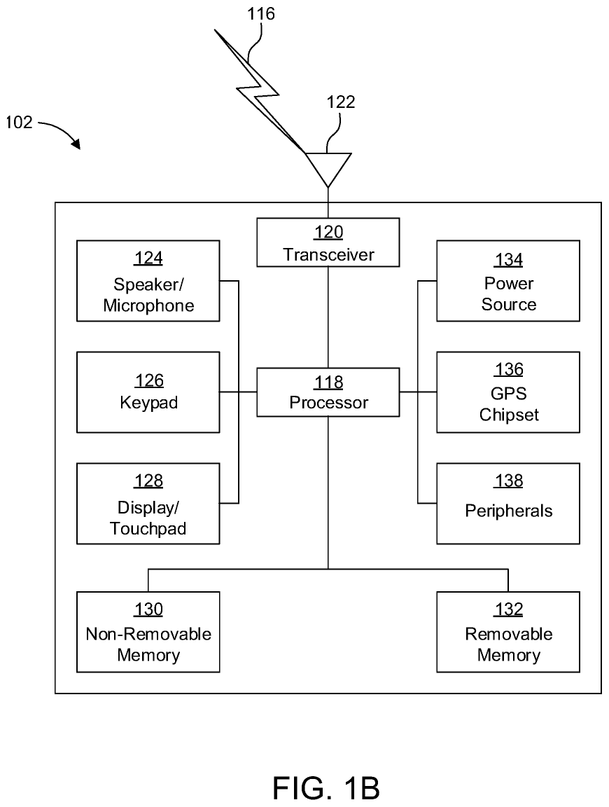

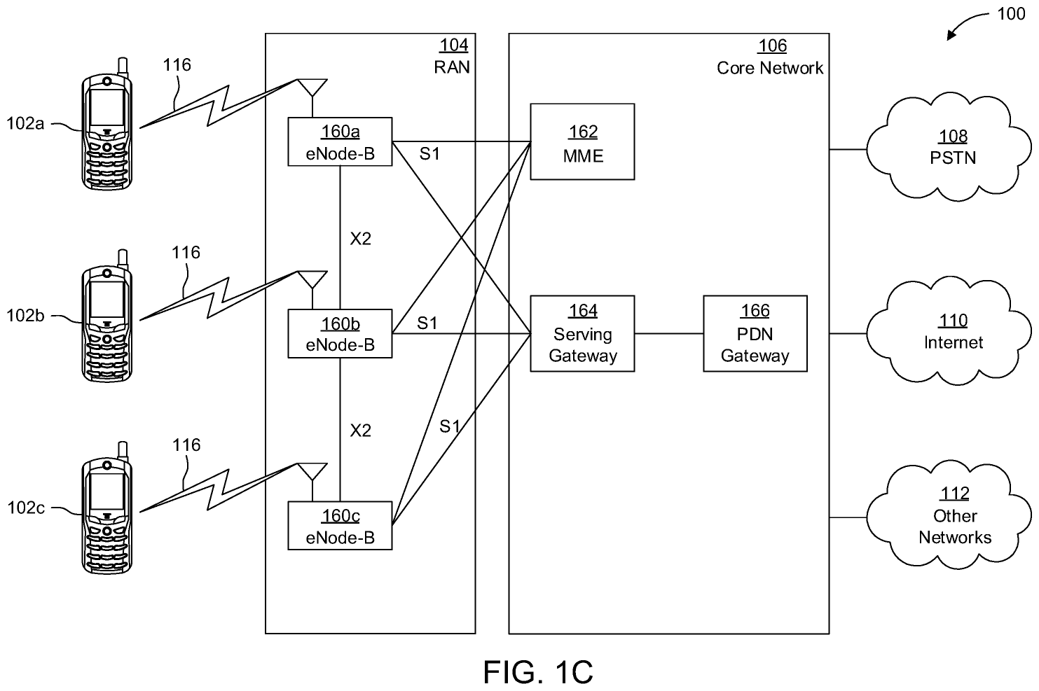

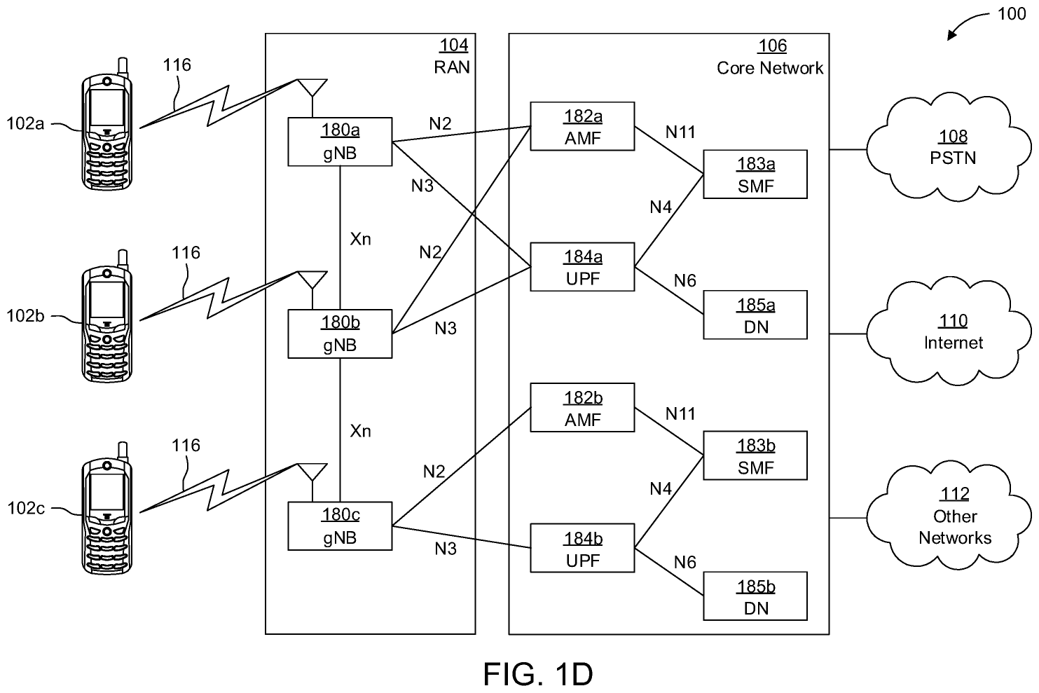

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using an 802.11ac infrastructure mode of operation, an AP may transmit a beacon on a fixed channel, such as a primary channel. This channel may be 20 MHz wide and may be the operating channel of the BSS. This channel may also be used by the STAs to establish a connection with the AP. A channel access mechanism in an 802.11 system is Carrier Sense Multiple Access with Collision Avoidance (CSMA/CA). In this mode of operation, every STA, including the AP, may sense the primary channel. If the channel is detected to be busy, the STA may back off. Hence, only one STA may transmit at any given time in a given BSS.

In 802.11n, High Throughput (HT) STAs may use a 40 MHz wide channel for communication. This may be achieved by combining a primary 20 MHz channel with an adjacent 20 MHz channel to form a 40 MHz wide contiguous channel.

In 802.11ac, Very High Throughput (VHT) STAs may support 20 MHz, 40 MHZ, 80 MHZ, and 160 MHz wide channels. The 40 MHz and 80 MHz channels may be formed by combining contiguous 20 MHz channels similar to 802.11n. A160 MHz channel may be formed by combining eight contiguous 20 MHz channels or by combining two non-contiguous 80 MHz channels, which may also be referred to as an 80+80 configuration. For the 80+80 configuration, the data, after channel encoding, may be passed through a segment parser that may divide it into two streams. An inverse Discrete Fourier Transformation (IDFT) operation and time-domain processing may be done on each stream separately. The streams may then be mapped to the two channels and the data may be transmitted. At the receiver, this procedure is reversed and the combined data may be sent to the MAC.

To improve spectral efficiency, 802.11ac introduced the concept for downlink Multi-User MIMO (MU-MIMO) transmission to multiple STAs in the same symbol's time frame, for example, during a downlink OFDM symbol. The potential for the use of downlink MU-MIMO is also currently considered for 802.11ah. Since downlink MU-MIMO, as it is used in 802.11ac, uses the same symbol timing to multiple STAs, interference of a waveform transmission to multiple STAs is not an issue. However, all STAs involved in MU-MIMO transmission with the AP use the same channel or band and this may limit the operating bandwidth to the smallest channel bandwidth that is supported by the STAs which are included in the MU-MIMO transmission with the AP.

An IEEE 802.11 Extremely High Throughput (EHT) Study Group was formed in September 2018. EHT is considered the next major revision to IEEE 802.11 standards following 802.11ax. EHT is formed to explore the possibility to further increase peak throughput and improve efficiency of the IEEE 802.11 networks. Following the EHT Study Group, the 802.11be Task Group was established to provide for 802.11 EHT specifications. The primary use cases and applications addressed include high throughput and low latency applications such as video-over-WLAN, augmented reality (AR), and virtual reality (VR).

A list of features that have been discussed in the EHT study group and 802.11be to achieve a target of increased peak throughput and improved efficiency include: multi-AP coordination, multi-band/multi-link, 320 MHz bandwidth, 16 spatial streams, HARQ, and new designs for 6 GHz channel access.

An IEEE 802.11bf standard will be a new amendment to IEEE 802.11 for wireless sensing capability in WLAN. A new task group, TGbf, has been formed to generate the specification documents, which may include the following. A sensing procedure may allow a STA to perform WLAN sensing and obtain measurement results. A sensing session may be an instance of a sensing procedure with associated operational parameters of that instance. A sensing initiator may be a STA that initiates a WLAN sensing session. A sensing responder may be a STA that participates in a WLAN sensing session initiated by a sensing initiator. A sensing transmitter may be a STA that transmits physical layer protocol data unit (PPDUs) that may be used for sensing measurements in a sensing session. A sensing receiver may be a STA that receives PPDUs sent by a sensing transmitter and may perform sensing measurements in a sensing session. A STA may assume multiple roles in one sensing session. In a sensing session, a sensing initiator may be a sensing transmitter, a sensing receiver, both, or neither.

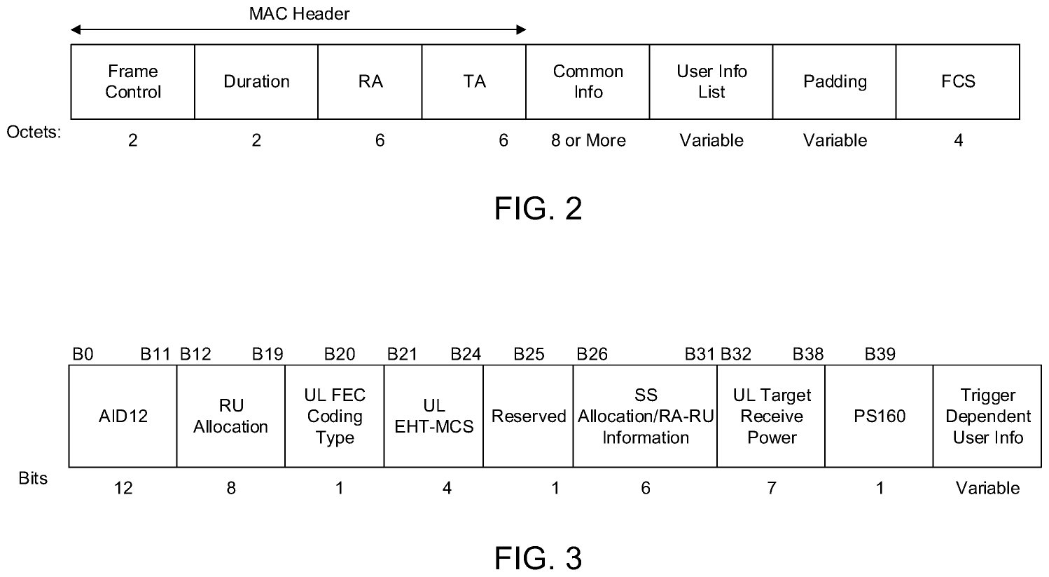

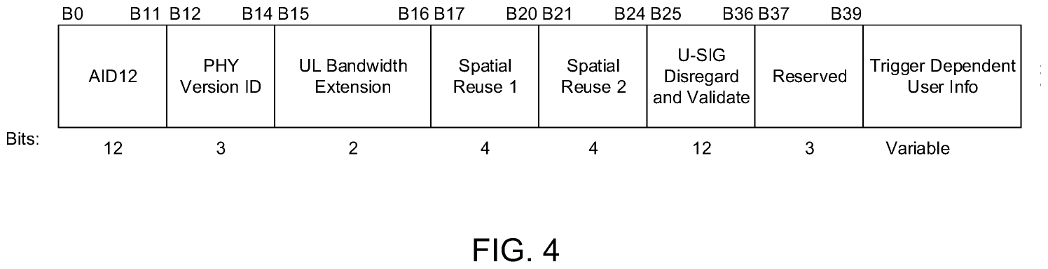

A trigger frame was introduced in 802.11ax to allocate resources and trigger single or multi-user access in the uplink. An example trigger frame format is shown in FIG. 2. In 802.11be, a new variant of a User Info field is proposed, as shown in FIG. 3. A Special User Info field may be added after the Common Info field, as shown in FIG. 4. Both enhancements, as shown in FIG. 3 and FIG. 4, allow a unified triggering scheme for both HE and EHT devices. FIG. 5 shows an example of a Common Info field of a Trigger frame.

Table 1 shows an example of a Trigger Type subfield encoding.

TABLE 1
Trigger Type subfield encoding

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-MAR |
| 6 | Bandwidth Query Report Poll (BQRP) |
| 7 | NDP Feedback Report Poll (NFRP) |
| 8 | Ranging |
| 9-15 | Reserved |

A Ranging Trigger Subtype field value in a Trigger Dependent Common Info field of a Ranging Trigger frame may signal Ranging Trigger frame subvariants and may be defined as shown, for example, in Table 2.

TABLE 2
Ranging Trigger Subtype field encoding

| Ranging Trigger Subtype field value | Ranging Triger frame subvariant |
|---|---|
| 0 | Poll |
| 1 | Sounding |
| 2 | Secure Sounding |
| 3 | Report |
| 4 | Passive TB sounding |
| 5-15 | Reserved |

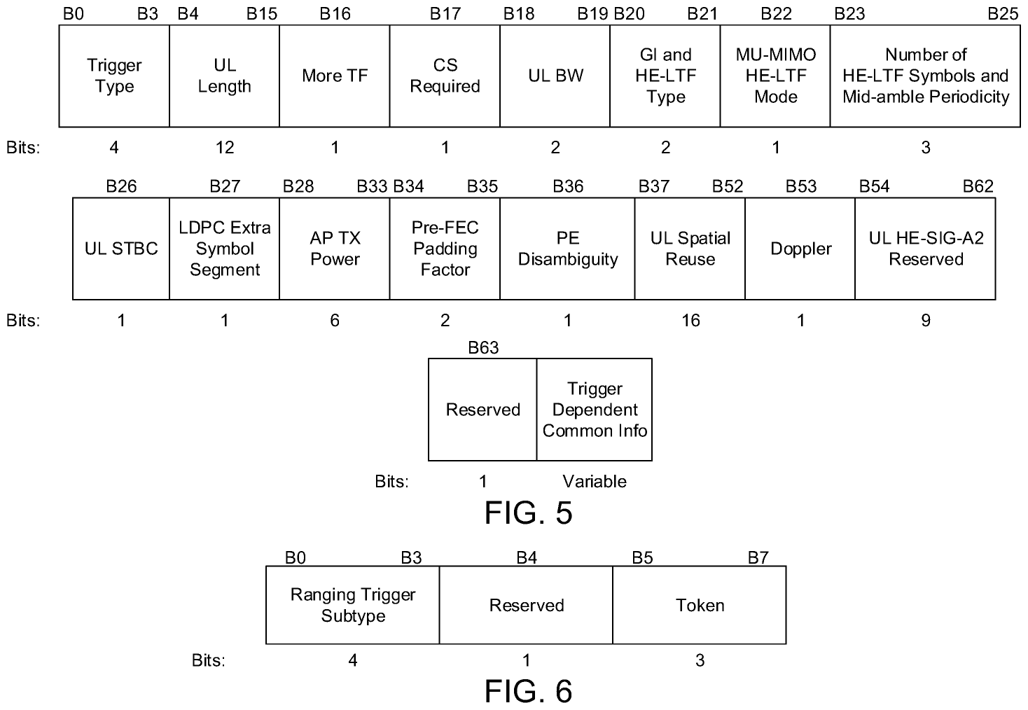

A format of a Trigger Dependent Common Info subfield for the Ranging Trigger frame of subvariant Poll, Sounding, Secure Sounding and Report is shown, for example, in FIG. 6. A Token field in the Trigger Dependent Common Info field may be used in a Ranging Trigger frame of subvariant Poll to match it with a partial Time Synchronization Function (TSF) time in a following Ranging NDP Announcement frame. It may be reserved in all other Ranging Trigger subvariants.

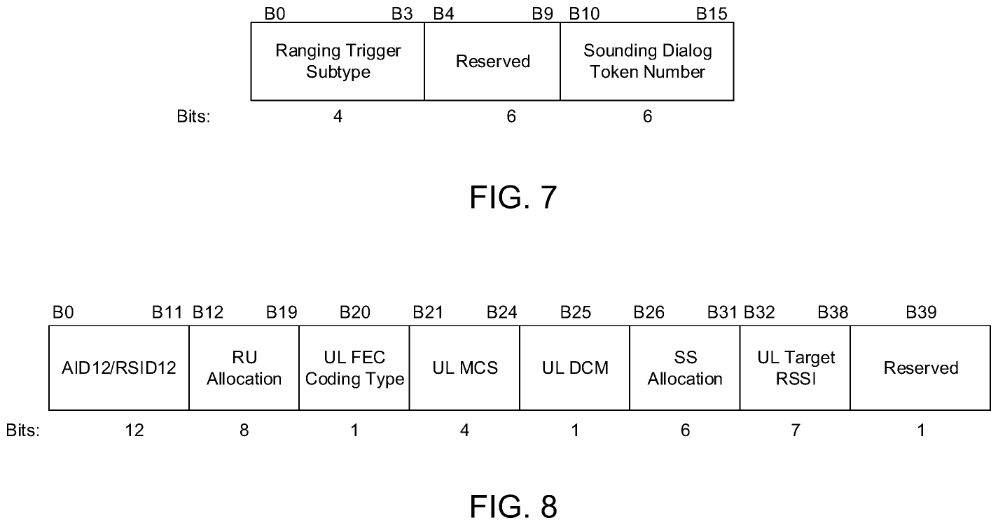

A format of a Trigger Dependent Common Info subfield of Ranging Trigger frame of subvariant Passive TB Sounding is shown, for example, in FIG. 7. A Sounding Dialog Token Number subfield may contain a value in a range of, for example, 0 to 63 which may identify a Measurement Sounding phase (12RNDP and R21 NDP announced by a Sounding Trigger frame and the Ranging NDP Announcement frame, respectively), and a same value may be included in the Sounding Dialog Token field of the Ranging NDP Announcement frame transmitted within the same Availability Window.

An RA field in the Ranging Trigger Frame and a CS Required and UL BW subfields in the Common Info field of the Ranging Trigger frame may be identical to a Basic Trigger frame, except that the RA field in Ranging Trigger frames with only one User Info field may be either unicast or broadcast.

A More TF subfield of a Common Info field of a Ranging Trigger frame may be set to 1 and an RA field may be set to a broadcast address to indicate that a subsequent Ranging Trigger frame of Poll subvariant may be scheduled for transmission within an availability window. The More TF subfield of the Common Info field of the Ranging Trigger frame may be set to 0 and the RA field may be set to the broadcast address to indicate that no subsequent Ranging Trigger frame of Poll subvariant is scheduled for transmission within the availability window.

A TA field for a Ranging Trigger frame may be set to an address of a responding STA (RSTA) transmitting a Trigger frame if the Trigger frame is addressed only to initiating STAs (ISTAs) with which that RSTA has a TB Ranging measurement exchange. The TA field may be the transmitted BSSID if the Trigger frame is addressed to a set of ISTAs in which at least two ISTAs have a TB Ranging Measurement exchange with a different BSSID in a Multiple BSSID set of the RSTA.

A format of a User Info field in a Ranging Trigger frame of Poll and Report subvariants is shown, for example, in FIG. 8. A Trigger Dependent User Info subfield may not present in the Poll subvariant and Report subvariant of the Ranging Trigger frame.

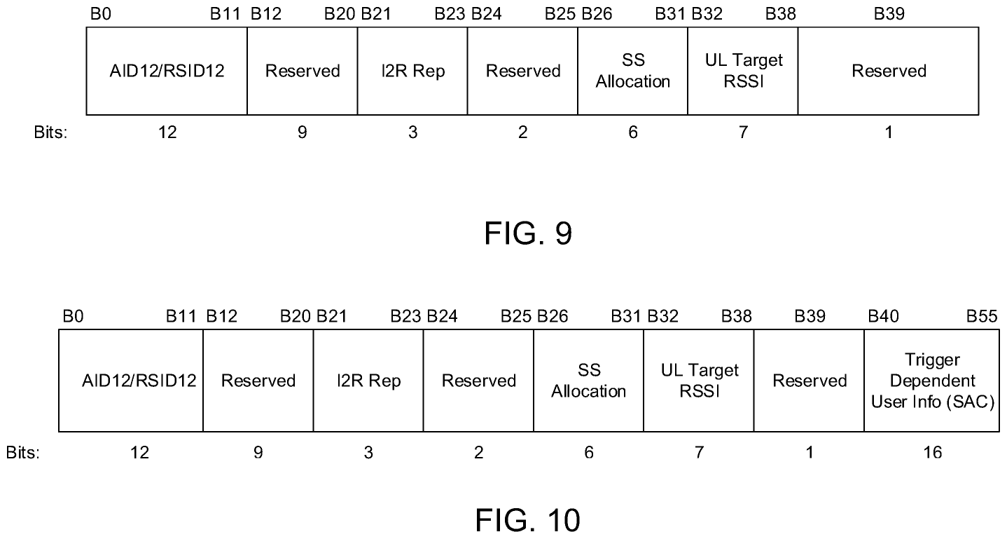

A format of a User Info field in a Ranging Trigger frame of Sounding subvariant is shown, for example, in FIG. 9. A format of a User Info field in a Ranging Trigger frame of Secured Sounding subvariant is shown, for example, in FIG. 10.

A Trigger Dependent User Info subfield may not present in the Sounding subvariant of the Ranging Trigger frame. In FIG. 9, the AID12/RSID12 subfield may carry either the 12 LSBs of the association ID (AID) for an associated ISTA or the 12 LSBs of the ranging session ID (RSID) for an unassociated ISTA. An UL Target RSSI subfield may be identical to a corresponding subfield in a Basic Trigger frame. The AID12/RSID12 subfield may be identical to a corresponding subfield in the Ranging Trigger frame of subvariant Poll. The 12R Rep subfield may signal a number of repetitions, N_REP, of the HE long training field (LTF) symbols in a corresponding HE TB Ranging NDP from the STA indicated in a AID12/RSID12 subfield. The value of the 12R Rep subfield may be the same in all User Info fields in the Trigger frame. The SS Allocation and UL Target RSSI subfields may be identical to the corresponding subfields in the Basic Trigger frame.

In FIG. 10, the AID12/RSID12 subfield may be identical to a corresponding subfield in a Ranging Trigger frame of subvariant Poll. The 12R Rep subfield may signal a number of repetitions, N_REP, of the HE LTF symbols in a corresponding HE TB Ranging NDP from the STA indicated in the AID 12/RSID12 subfield. The SS Allocation and UL Target RSSI subfields may be identical to a corresponding subfield in the Basic Trigger frame. The Trigger Dependent User Info subfield may be present in the Ranging Trigger frame of Secured sounding subvariant as shown in FIG. 10. The Trigger Dependent User Info subfield may carry a Security Authentication Code (SAC) field. The SAC field may provide the authentication information for the LTF Sequence Generation information used for the 12R sounding associated with the measurement instance. The length of this subfield may be 16 bits.

The Ranging Trigger frame of Passive TB Ranging subvariant may follow the definition of the Ranging Trigger frame of Sounding subvariant except that the RA field may be set to a broadcast address and the 12R Rep subfield may signal the number of repetitions, N_REP, of the HE LTF symbols in the corresponding HE Ranging NDP from the STA indicated in the AID12/RSID12 subfield.

There may be variants of a null data packet announcement (NDPA) in 802.11, as shown in Table 3.

TABLE 3
NDPA frame variant encoding

| NDPA Type subfield | NDP Announcement frame variant |
|---|---|
| 0 | VHT NDP Announcement frame |
| 1 | Ranging NDP Announcement frame |
| 2 | HE NDP Announcement frame |
| 3 | EHT NDP Announcement frame |

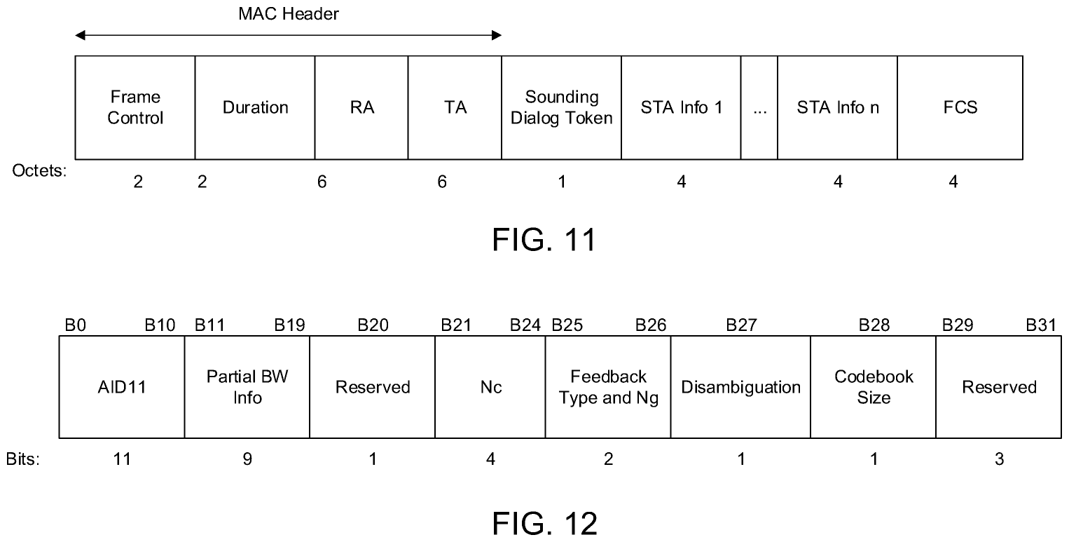

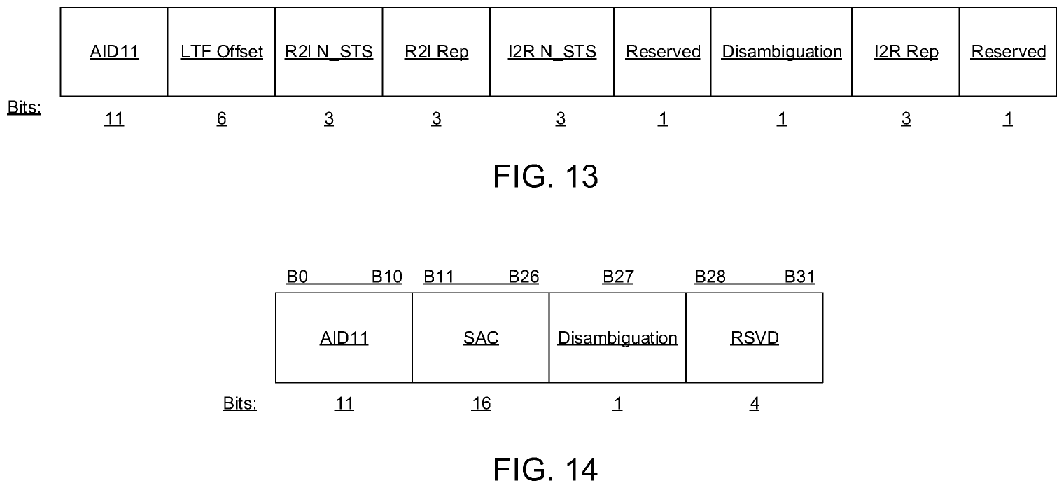

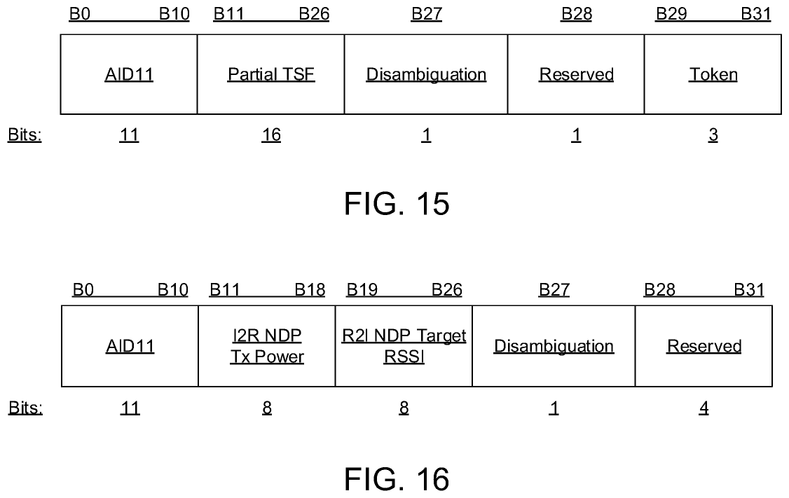

A NDPA announcement frame format is shown in FIG. 11. A STA Info field of an EHT NDPA variant is shown in FIG. 12. A STA Info field of an HE Ranging NDPA variant is shown in FIG. 13. The Special STA Info field formats of HE Ranging are shown in FIGS. 14-16.

Preamble puncturing was introduced in 802.11ax to allow a STA to transmit on certain subchannels but not the entire bandwidth. The preamble puncturing transmission of a PPDU may have no signal present in one or more subchannels within the PPDU bandwidth. In 802.11be, there are two type of preamble puncturing schemes: static puncturing and dynamic puncturing.

For static puncturing, one or more subchannels may be punctured for one or more Beacon intervals. An AP may add a Disabled Subchannel Bitmap field in an EHT Operation element to indicate one or more subchannels are disabled. STAs may set a TXVECTOR parameter INACTIVE_SUBCHANNELS of an HE, EHT, or non-HT duplicate PPDU based on a value indicated in the most recently exchanged Disabled Subchannel Bitmap field in the EHT Operation element for that BSS. STAs may not transmit anything on the disabled subchannels.

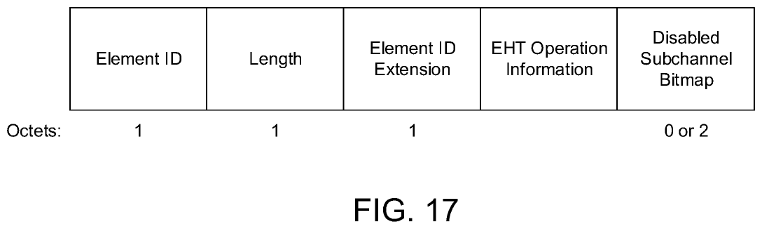

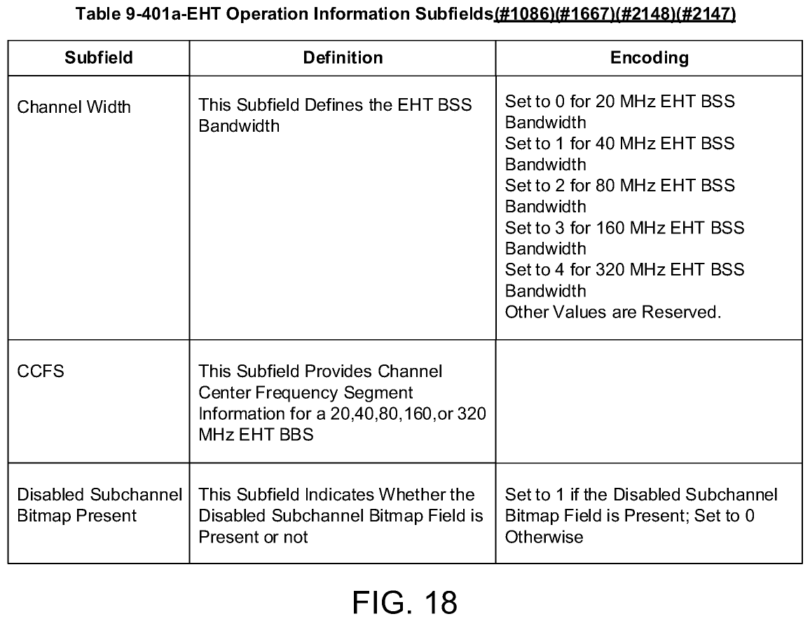

An EHT Operation element, for example as in 802.11be, is shown in FIG. 17. The subfields of an EHT Operation Information field are shown in FIG. 18.

A Disabled Subchannel Bitmap may be two octets long if present. With dynamic puncturing, a STA may be allowed to puncture additional subchannels other than the ones indicated by a Disabled Subchannel Bitmap field. The STA may determine to puncture additional subchannels for different reasons. For example, it may be based on its physical or virtual channel sensing results. Dynamic puncturing may be explicitly signaled using a field such as a U-SIG field in a EHT MU PPDU. The Punctured Channel Information field may be carried in a field such as a U-SIG field in a EHT MU PPDU to indicate the punctured channels.

An AP may solicit a NDP transmission from one or more non-AP STAs in the uplink to enable uplink sensing. The NDPs may be transmitted on orthogonal resources or transmitted non-orthogonally on an entire non-punctured bandwidth. Enabling the non-orthogonal uplink sensing through the transmission of NDPs on the entire non-punctured bandwidth may be a problem.

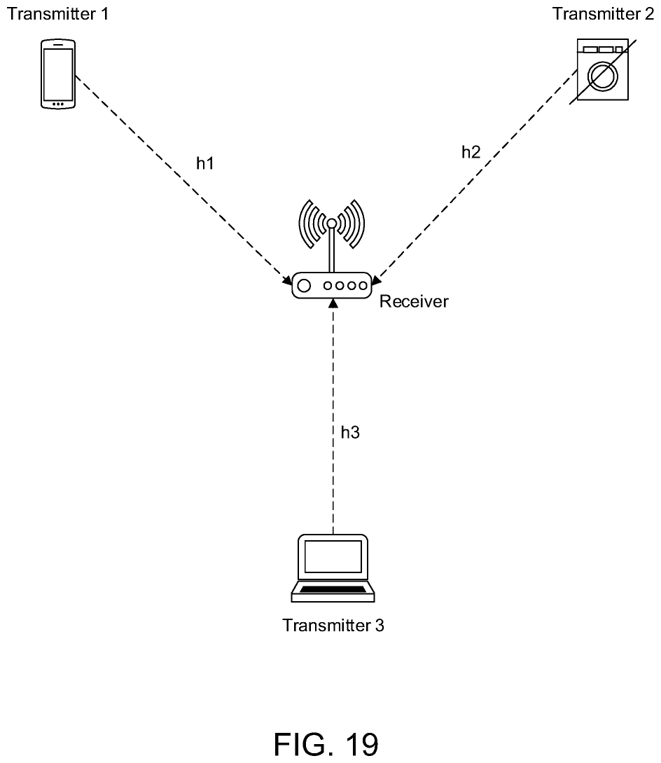

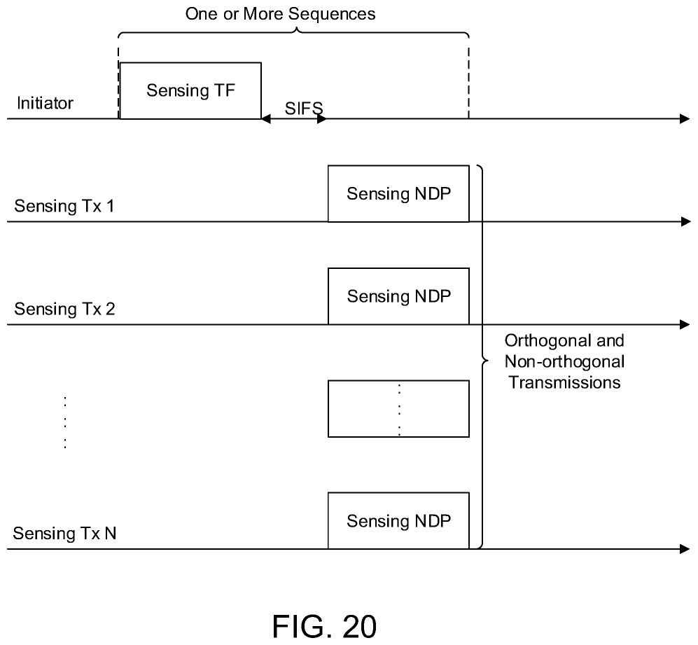

FIG. 19 shows a system model for non-orthogonal NDP transmission. In an embodiment, a sensing initiator (e.g. Receiver) in trigger based (TB) sensing may solicit NDP transmissions in uplink sounding (e.g. trigger frame (TF) sounding phase) such that the NDP may be sent from different sensing transmitters (e.g. Transmitter 1, Transmitter 2, and Transmitter 3) on the same resources (e.g. frequency, time, and spatial stream) in non-orthogonal transmission. The received NDP at the sensing receiver may carry channel state information for a channel which may be an aggregate channel hₐ=h₁+h₂+h₃ of the individual channels between each sensing transmitter (e.g. Transmitter 1, Transmitter 2, and Transmitter 3) and the sensing receiver (e.g., h₁, h₂, and h₃) as shown in FIG. 19.

FIG. 20 shows an example method for non-orthogonal uplink sensing. In an embodiment, a sensing initiator (receiver) in trigger based (TB) sensing may solicit uplink NDP transmissions using a sensing trigger frame (TF) in one or more sequences such that each sequence starts with sending the sensing TF to solicit the NDP transmission after a short interframe space (SIFS) or other inter-frame spacing. The sensing initiator may solicit the NDP transmission on orthogonal and/or non-orthogonal resources in which the same or different sensing transmitters may be triggered in each triggering sequence as shown in FIG. 20. Each sensing transmitter (e.g. Tx1 . . . . TxN) may send a sensing NDP.

In an embodiment, a sensing initiator in TB sensing may group the sensing transmitters based on location information such that a group of sensing transmitters located in a same room/area may be triggered to send the NDP on non-orthogonal resources. In an embodiment, groups of sensing transmitters located in different rooms/areas may be triggered in different times and/or using orthogonal frequency resources and/or on different spatial streams and/or using any other resource.

In an embodiment, a sensing initiator in TB sensing may alternate between using orthogonal resources or non-orthogonal resources to solicit a NDP transmission from different sensing transmitters according to the sensing needs. In an example, a sensing initiator may switch between collecting coarse sensing results using non-orthogonal resources to collecting fine sensing results using orthogonal resources. In an example, a sensing initiator may sense the activities taking place in a specific room/area or identify a location where a sensed activity is happening.

In an embodiment, a sensing initiator in TB sensing may group the sensing transmitters based on their capabilities such that a group of transmitters supporting a same set of capabilities may be triggered to send a NDP in a same triggering sequence. The sensing transmitters may be grouped based on at least one of: a NDP format they support, a number of transmit antennas, or a maximum number of LTF repetitions.

In an embodiment, a sensing initiator in TB sensing may synchronize the NDP transmissions from different sensing transmitters to reach the sensing receiver at the same time. The sensing initiator may apply a power control procedure such that the solicited NDP transmissions reach the sensing receiver with the same received power to avoid a near-far problem.

In an embodiment, the sensing transmitters may transmit the NDP on the non-punctured subchannels in the BSS operating channel. The sensing initiator may solicit the NDP transmissions by indicating the bandwidth and the list of non-punctured subchannels in the sensing trigger frame.

In an embodiment, the sensing initiator in TB sensing may solicit the NDP transmission from the sensing transmitters in non-orthogonal resources by addressing a range of STAs rather than addressing each individual STA in a separate User Info field in a sensing trigger frame. In an example, the sensing initiator may signal the AID of the first STA in the group and the number of STAs expected to send the NDP on the non-punctured BSS operating bandwidth. In an example, the sensing initiator may signal an indication of the number of STAs, for example N ∈ {0,1,2,3}, such that the number of STAs, N_{STA}, may be computed as: N_{STA}=2^{N}×8.

In an embodiment, a sensing initiator (e.g. AP) in a TB measurement instance may periodically solicit orthogonal NDP transmissions from the sensing transmitters to allow for computations that may be used in power control and/or time synchronization. Alternating between orthogonal and non-orthogonal NDP transmission may be decided by the sensing initiator and scheduled in the sensing measurement setup. In an example, the orthogonal NDP transmissions for power control and fine time synchronization may be decided by the sensing initiator and solicited using the sensing trigger frame.

In an embodiment, an RU Allocation subfield of the User Info field in a Sensing TF may indicate the resource in which the NDP may be transmitted. One or more patterns for the RU/MRU allocation may be used to indicate that the transmission is using an entire non-punctured BSS bandwidth. The RU/MRU allocation patterns used for soliciting the NDP transmission over the entire BSS bandwidth may also indicate different puncturing patterns in the solicited NDP transmission.

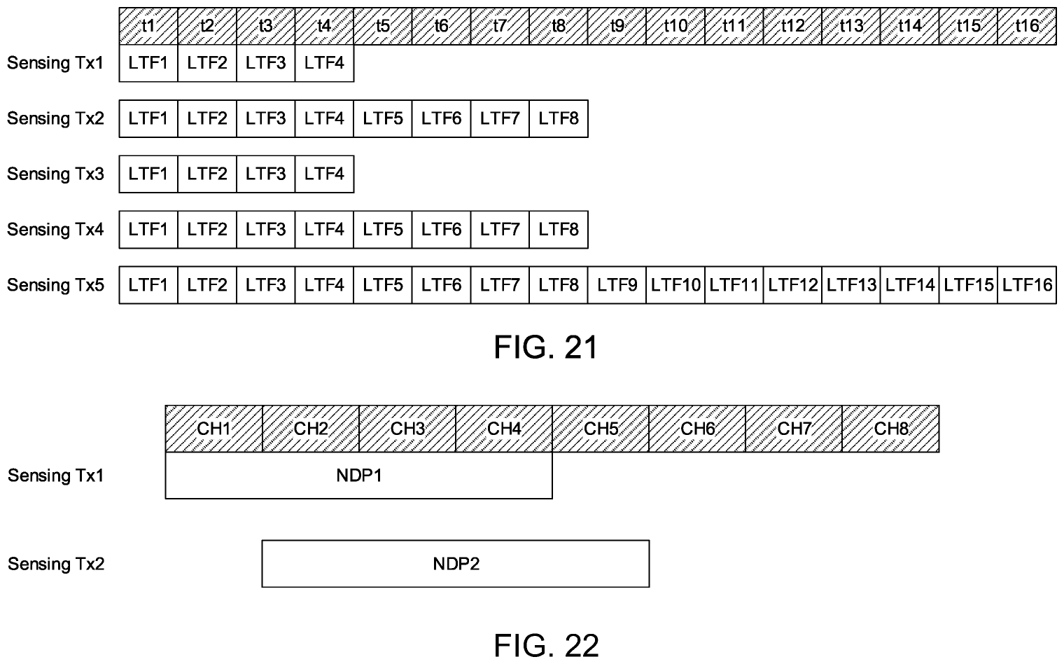

FIG. 21 shows an example of different LTF repetitions for different sensing transmitters in uplink (UL) sensing. In an embodiment, a sensing initiator may indicate different LTF repetitions for different sensing transmitters solicited to transmit NDP over a same frequency/spatial resources as shown in FIG. 21. Accordingly, the NDP transmissions may be non-orthogonal for all sensing transmitters in some repetitions of the LTF (e.g., at t1), non-orthogonal for some of the sensing transmitters in some repetitions of the LTF (e.g., at t5), or orthogonal for some of the sensing transmitters in some repetitions of the LTF (e.g., 19-t16 for Sensing Tx5).

FIG. 22 shows an example of overlapped uplink NDP transmission. In an embodiment, a sensing initiator may allocate different resources to the sensing transmitters to send the NDP in the uplink such that the bandwidth of the NDP for one of the transmitters may overlap with the bandwidth of the NDP of other sensing transmitters as shown in FIG. 22. For example, NDP1 of sensing Tx 1 over channels 2, 3, and 4 may overlap with NP2 of sensing Tx2 over channels 2, 3, and 4.

In an embodiment, one or more STAs may be grouped together based on their channel conditions and may send a NDP according to at least one of the following options: Option 1 for SNR gain; Option 2 for diversity gain; and Option 3 for resolution-SNR trade off.

For Option 1 (SNR gain), the STAs that experience similar channel gains or the STAs that are close to each other may be grouped together and transmit non-orthogonal NDPs. Since the channel gains may be approximately similar from the STAs that are close to each other, the signal arriving at the STA responder receiver may constructively superimpose, thereby providing the beamforming gains. This may mathematically be expressed as: y=Σᵢ₌₁^{N}hᵢxᵢ. With non-orthogonal and similar LTFs transmitted by each STA, we may rewrite the expression as y=xΣᵢ₌₁^{N}hᵢ. Furthermore, the STAs may exhibit similar channel fading, hᵢ=h, ∀i, where h is the channel gain. Then we have, y=Nhx, where N is the beamforming gain providing higher SNR.

For Option 2 (diversity gain), the STAs that experience different fading may be grouped together for non-orthogonal transmission. This may mathematically be expressed as: y=Σᵢ₌₁^{N}hᵢxᵢ, where hᵢ≠hⱼ. Then the received signal vector at the STA responder receiver may exhibit diversity of order N.

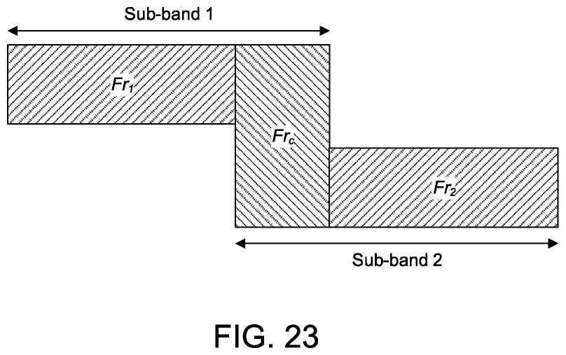

For Option 3 with partial overlap with reuse factor, Fᵣ (resolution-SNR trade off), STAs that are close to each other or experience similar channel fading with a certain degree of correlation may overlap partially for non-orthogonal transmission. The overlapping frequencies may provide the beamforming gain for improving the SNR as described in Option 1, while the orthogonal parts may be concatenated together to increase the effective bandwidth for resolution. Depending on the reuse factor, Fᵣ, which may be defined as the ratio of the total sub-band and the partial sub-band used for non-orthogonal transmission, (e.g. for STA with sub-band, Fr₁, Fᵣ=Fr_{c}/Fr₁, where Fr_{c} is the overlapped frequencies/sub-band), the STAs may be scheduled for interplay between the resolution and SNR. FIG. 23 shows an example of non-orthogonal transmission with overlapped channels and indicates the resolution-SNR trade off.

The bands Fr₁, and Fr₂ may be concatenated together to form a larger effective bandwidth, i.e. with a bandwidth of Fr₁+Fr₂-Fr_{c}, to improve the resolution. The higher the Fr_{c}, the lower the resolution, but higher the beamforming gain.

The transmit power on overlapped resources and non-overlapped resources may be set differently so that the power of the received signal over the whole resources (i.e., channel bandwidth) may be balanced. The transmit powers for overlapped and non-overlapped resources for different sensing transmitters may be signaled by the sensing initiator via a NDPA or a Trigger frame.

In all the above options, a group ID for STAs that are grouped together pertaining to each option may be specified.

In WLAN sensing, a NDP may be used both in the uplink and in the downlink to perform channel measurements. The format of the selected NDP may need to satisfy the requirements of sensing both in the uplink and downlink and the requirements of trigger based (TB) and non-trigger-based sensing. Further, STAs from different generations may participate in a sensing session, and for successful operation, the support of different NDP formats may be required. A procedure to enable the support of different sensing NDPs is needed.

In an embodiment, several different NDP formats such as HE NDP, HE Ranging NDP, and EHT NDP may be used in sensing measurement instances. The sensing initiators and the sensing responders may indicate the support of one or more NDP formats in the sensing capabilities element or any other element that may be used to indicate the support of optional features in sensing.

In an embodiment, the NDP format used in a sensing measurement setup may be negotiated by the sensing initiator and the sensing responder or may be determined by the sensing initiator based on the announced capabilities of the sensing responders.

In an embodiment, the sensing initiator may group the sensing responders based on their announced capabilities such that the NDP format used may be supported by all the sensing transmitters and receivers in each sensing measurement instance. In an example, a HE Ranging NDP may be used in a sensing measurement instance for a group of STAs that can support HE Ranging NDP format based on the announced capabilities or the negotiated attributes of a sensing measurement setup.

In an embodiment, the sensing initiator may indicate the format of the NDP used in a TB sensing measurement instance. In an example, the sensing initiator may indicate the NDP format in the NDPA for a downlink sensing measurement instance. The NDP format may be indicated in a Common Info field or a Special STA Info field. In an example, the NDP format may be indicated in the sensing trigger frame for an uplink sensing measurement instance in the Common Info field or in a Special User Info field.

In an embodiment, different NDP formats may be solicited in the NDPA sounding phase and the TF sounding phase of a TB measurement instance. In an example, an EHT Sounding NDP may be solicited in the NDPA sounding phase and a HE TB Ranging NDP may be solicited in the TF sounding phase. In an example, an EHT TB NDP may be solicited in the TF sounding phase while a HE Ranging NDP may be solicited in the NDPA sounding phase. Other combinations of soliciting different formats of NDP may be supported.

In a TB sensing measurement instance, several variants of trigger frames may be used for various functions which may include polling the users to indicate their availability to participate in the sensing measurement instance, soliciting uplink NDP transmissions, and collecting the sensing measurement results. A design of the sensing trigger frame variants is needed.

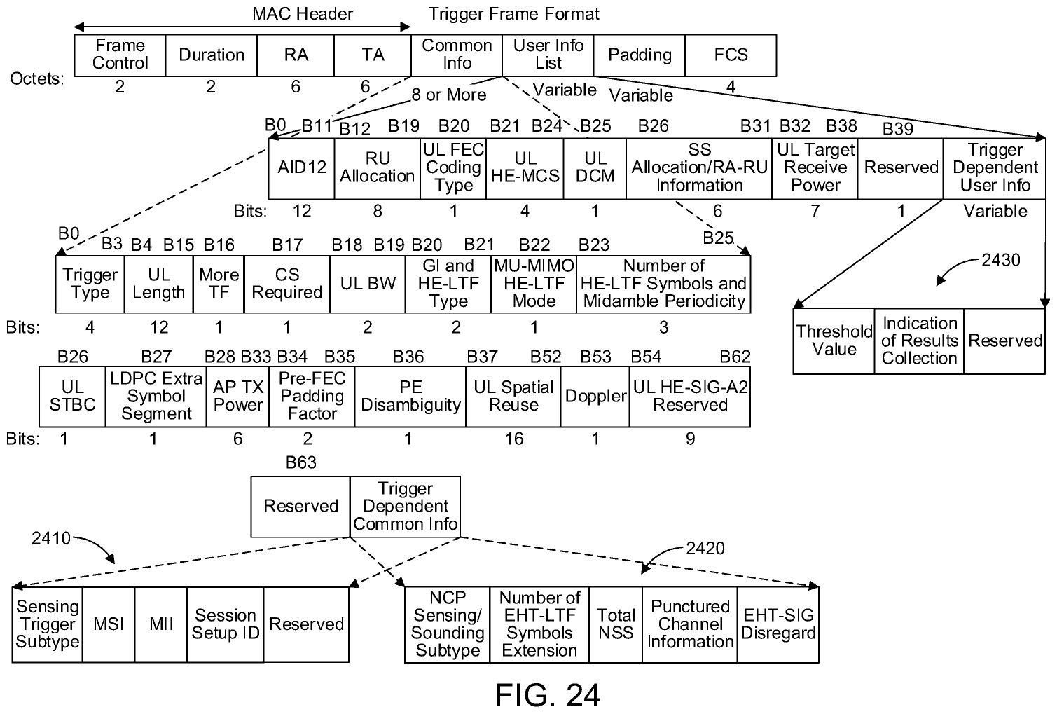

FIG. 24 shows an example trigger frame format for wireless local area network (WLAN) sensing. An example of sensing subfields of a Trigger Dependent Common Info subfield of a Common Info field of a trigger frame are shown in 2410. The sensing subfields may include a Sensing Trigger Subtype subfield, a measurement setup identification (MSI) subfield, a measurement instance identification (MII) subfield, a session setup identification subfield, and s reserved subfield. These sensing subfields may be included when, for example, a trigger type is ranging or sensing. An example of sensing subfields of a Trigger Dependent Common Info subfield of a Common Info field of a trigger frame are shown in 2420. The sensing subfields may include a NDP Sensing/Sounding Subtype subfield, a Number of Extremely High Throughput (EHT)—Long Training Field (LTF) Symbols Extension subfield, a Total Number of Spatial Streams (NSS) subfield, a Punctured Channel Information subfield, and an EHT-SIG Disregard subfield. These sensing subfields may be included when, for example, a trigger type is NDP Sounding Poll. These sensing fields may be used in an EHT trigger frame that is used for sensing. An example of sensing subfields of a Trigger Dependent User Info subfield of a user Info field of a trigger frame are shown in 2430. The sensing subfields may include a Threshold Value subfield, an Indication of Results Collection subfield, and a reserved subfield.

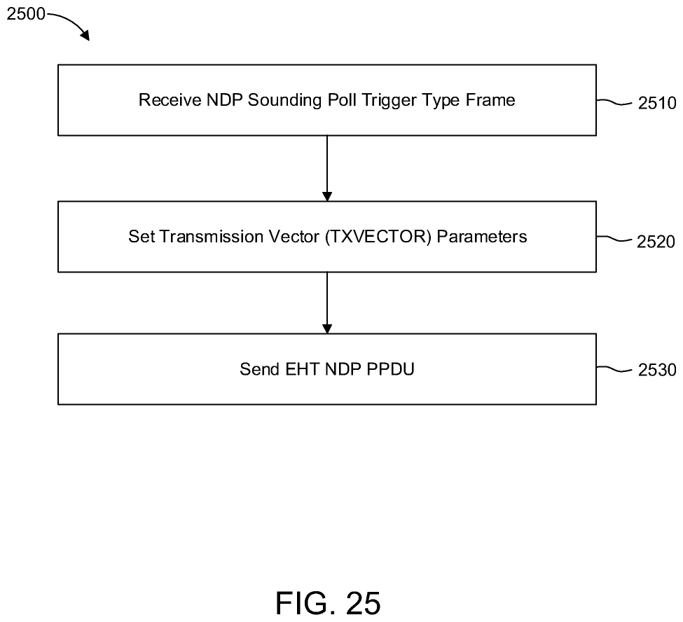

FIG. 25 shows an example method for WLAN sensing (2500). A sensing STA may receive a trigger frame (2510). The trigger frame may be a NDP Sounding Poll trigger type. The sensing STA may set transmission vector (TXVECTOR) parameters (2520). The sensing STA may respond to the received trigger frame (2530). The sensing STA may respond with EHT NDP PPDUs. The sensing STA may respond after a SIFS.

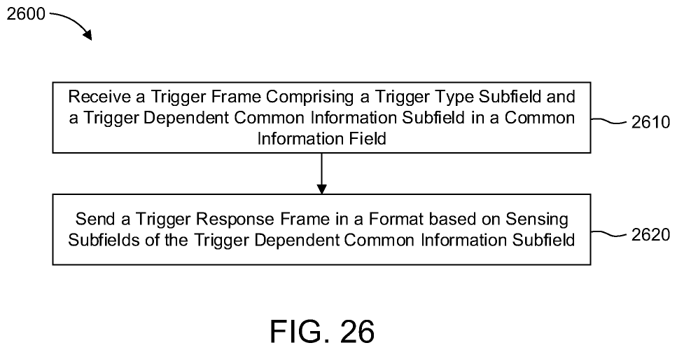

FIG. 26 shows a method for wireless local area network (WLAN) sensing (2600). A STA may receive a trigger frame (2610). The trigger frame may comprise at least a common information field. The common information field may comprise at least a trigger type subfield. The common information field may comprise at least a trigger dependent common information subfield. The trigger dependent common information subfield may comprise sensing subfields. The sensing subfields may be based on a value of the trigger type subfield. The STA may send a trigger response frame (2620). A format of the trigger response frame may be at least based on at least one of the sensing subfields of the trigger dependent common information subfield. The trigger frame may further comprise a user information field. The user information field may comprise a trigger dependent user information subfield. The trigger dependent user information subfield may comprise at least a threshold value subfield and an indication of results collection subfield. Information in the trigger response frame may be at least based on the threshold value subfield and the indication of results collection subfield. The trigger type subfield value may indicate a ranging trigger frame variant or a null data packet (NDP) sounding poll trigger frame variant. On a condition that the trigger type subfield value indicates a ranging trigger frame variant, the sensing subfields of the trigger dependent common information subfield may comprise at least one of: a sensing trigger subtype subfield, a measurement setup identification (MSI) subfield, a measurement instance identification (MII) subfield, or a session setup identification subfield. The sensing trigger subtype subfield may comprise information indicating a sensing trigger frame subvariant. The sensing trigger frame subvariant may comprise one of: poll, null data packet (NDP) soliciting, report, threshold based result collection, or group NDP soliciting. On a condition that the trigger type subfield value indicates a NDP sounding poll frame trigger frame variant, the sensing subfields of the trigger dependent common information subfield may comprise at least one of: a NDP sensing/sounding subtype subfield, a number of extremely high throughput (EHT)—long training field (LTF) symbols extension subfield, a total number of spatial streams (NSS) subfield, a punctured channel information subfield, or an EHT-SIG disregard subfield. A reserved bit in the common information field may indicate that the trigger frame is for sensing. The transmitted trigger response frame may be a null data packet (NDP) physical layer protocol data unit (PPDU). The trigger response frame may be transmitted after a short interframe space (SIFS).

In an embodiment, a ranging trigger frame (i.e., Trigger Type subfield value equal to 8), may be repurposed for sensing.

A reserved bit (e.g., any bit from B56-B62 or B63) in a Common Info field of a HE variant may be used to indicate the trigger frame is for sensing or not sensing. For example, if the reserved bit is equal to a particular value (e.g. 1), it may indicate that the trigger frame is used for sensing. A reserved bit in a Trigger Dependent Common Info subfield of a Trigger frame may be used to indicate it is a sensing trigger frame or it is not a sensing trigger frame.

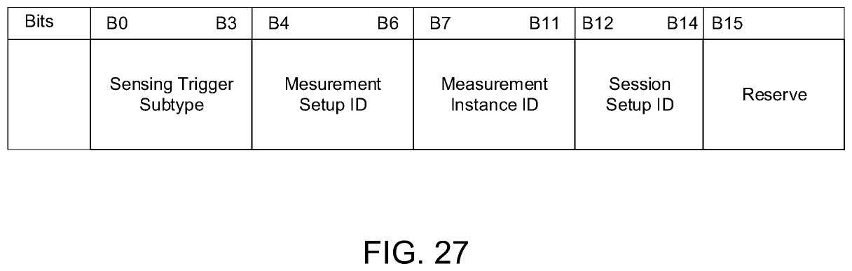

FIG. 27 shows an example Trigger Dependent Common Info subfield for a Sensing Trigger variant. A Trigger Dependent Common Info subfield may comprise one or more of the following subfields: a Sensing Trigger subtype, a Measurement Setup ID (MSI), a Measurement Instance ID (MII), a Session Setup ID, or other information as shown in FIG. 27. The actual number reserved for different subfields may be changed. The Measurement Setup ID and Measurement Instance ID may be combined as one field, for example, in a Dialog Token field.

A Sensing Trigger Subtype field value in a Trigger Dependent Common Info subfield may signal Sensing Trigger frame subvariants and may be defined as shown in Table 4.

TABLE 4
Sensing Trigger Subtype field encoding

| Sensing Trigger Subtype field value | Sensing Trigger frame subvariant |
|---|---|
| 0 | Poll |
| 1 | NDP Soliciting |
| 2 | Report |
| 3 | Threshold based result collection |
| 4 | Group NDP Soliciting |
| 5-7 | Reserved |

When the Sensing I rigger Subtype field value indicates that the Trigger frame is a Poll subvariant (e.g. the Sensing Trigger Subtype field value=0), the Trigger frame may be used to poll STAs. For example, an AP may send out a Sensing Trigger frame of Poll subvariant to check the availability of the STAs. The User Info field for a Sensing Trigger frame of subvariant Poll may include an AID12 (address ID of the recipient STA), RU Allocation, UL FEC Coding Type, UL MCS (if it solicits an EHT TB PPDU, then it may be UL EHT-MCS; it requests for HE TB PPDU, then it may comprise UL HE-MCS and DCM), UL Target RSSI, SS Allocation, PS 160 if it solicits a HE TB PPDU. The bits in the Common Info field (e.g., Bit 54 and Bit 55) and the bit in the User Info field may be used together to indicate it asking for an EHT TB PPDU or a HE TB PPDU. The number of User Info fields may be the number of STAs that are requested for sending the availability information. Once the STA receives the Trigger frame and determines that the identity of the AID address matches its address, it may send back the availability information using the TB PPDU indicated by the Trigger frame (e.g. combination of B54, B55 in the Common Info field and B39 in the User Info field).

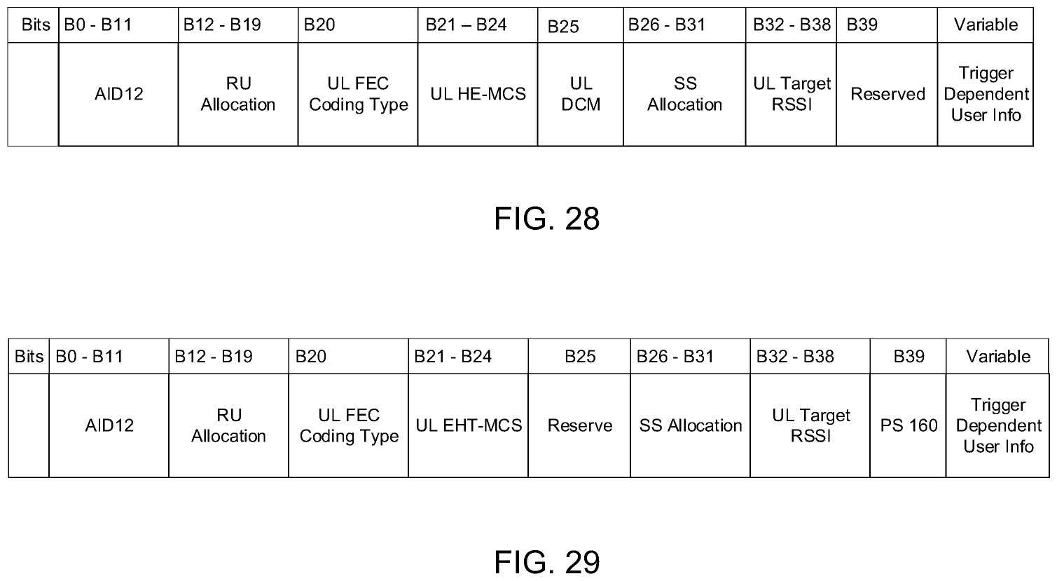

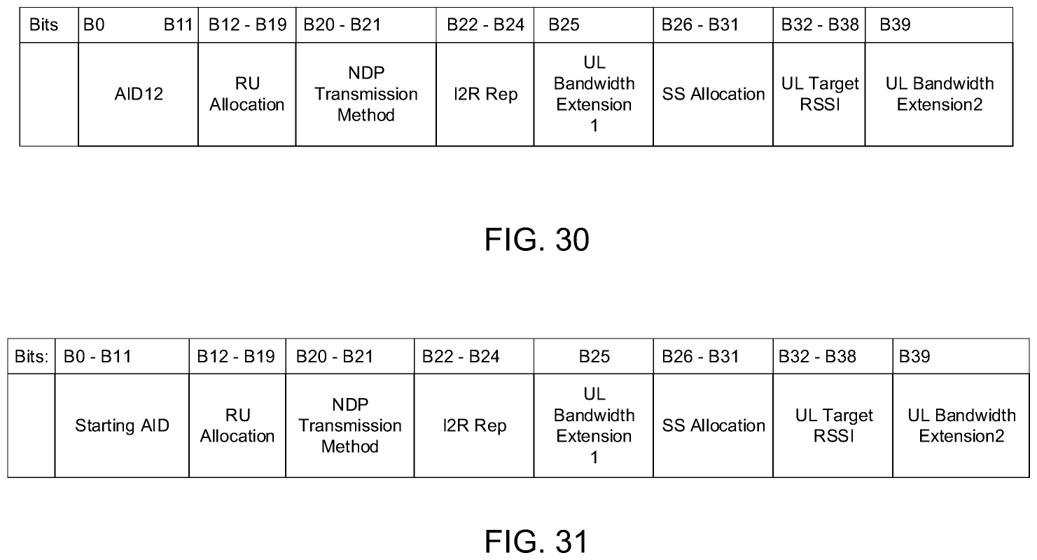

When the Sensing Trigger Subtype field value indicates that the Trigger frame is a Report subvariant (e.g. the Sensing Trigger Subtype field value=2), the Trigger frame may be used to collect sensing results from multiple STAs. A User Info field used for the Sensing Trigger frame of Poll subvariant may be used in the Sensing Trigger frame of Report subvariant. FIG. 28 shows an example User Info field for a Sensing Trigger frame of subvariant Poll or Report soliciting a response using a HE PPDU format. FIG. 29 shows an example User Info field for a Sensing Trigger frame of subvariant Poll or Report soliciting a response using an EHT PPDU format. In addition, a report quantization requirement (e.g., scaling factors of Channel State Information (CSI) used in the receiver side) may be included in a common field of a Trigger frame of Report subvariant. Alternatively, the report quantization requirement may be included in a Trigger Dependent User Info subfield of the User Info field.

When the Sensing Trigger Subtype field value indicates that the Trigger frame is a NDP Soliciting subvariant (e.g. the Sensing Trigger Subtype field value=1), the Trigger frame may be used to solicit multiple STAs to transmit NDP frames. FIG. 30 shows an example User Info field for a Sensing Trigger frame of subvariant NDP soliciting. One User Info field may be used for triggering one STA. The User Info field used for the Sensing Trigger frame of NDP soliciting subvariant may comprise, but is not limited to, AID12 (STA address), RU Allocation, NDP Transmission Method (which may indicate what transmission mechanisms are used for NDP transmission, for example, 00 may represent OFDMA transmission, 01 may represent multiple NDP simultaneous transmission over the allocated bandwidth, 10 may represent the case where multiple STAs transmit the NDP sequentially and one STA at one time, 11 may represent the case where simultaneous NDP transmissions are from a group of STAs over the allocated bandwidth at one time and multiple groups of STAs transmit NDPs in a sequential way), 12R Rep, SS Allocation UL Target RSSI, UL Bandwidth Extension 1 and Band Bandwidth Extension 2. The UL BW subfield in the Common Info field of the Trigger frame of subvariant NDP soliciting combined with the UL Bandwidth Extension 1 and the UL Bandwidth Extension 2 subfields may be used together to determine the bandwidth of a sensing NDP (e.g., the bandwidth of a sensing NDP may be up to 320 MHz). Table 5 shows the exemplary UL Bandwidth Extension subfields encoding.

TABLE 5
Example UL Bandwidth Extension subfield encoding

| | UL Bandwidth | UL Bandwidth | |
|---|---|---|---|
| UL BW subfield | Extension 1 in | Extension 2 in | Bandwidth for |
| in the Common | the User | the User | UL NDP |
| Info field | Info field | Info field | (MHz) |
| 0 | 0 | 0 | 20 |
| 1 | 0 | 0 | 40 |
| 2 | 0 | 0 | 80 |
| 3 | 0 | 0 | 160 |
| 3 | 0 | 1 | 320-1 |
| 3 | 1 | 0 | 320-2 |

When the Sensing Trigger Subtype field value indicates that the Trigger frame is a Group NDP Soliciting subvariant (e.g. the Sensing Trigger Subtype field value=4), the Trigger frame may be used to solicit multiple STAs to transmit NDP frames. One User Info field may be used for triggering multiple STAs or a group of associated STAs or a group of unassociated STAs. The User Info field used for the Sensing Trigger frame of Group NDP soliciting subvariant may comprise similar subfields as indicated in the NDP Soliciting subvariant except Starting AID. As shown in FIG. 31, a Starting AID subfield is included in the User Info field for a Sensing Trigger frame of subvariant Group NDP soliciting. The STAs which have an AID greater than or equal to a starting AID, using the value given in the Starting AID subfield, and less than starting AID+N_STA may be scheduled to send the NDP. The number of STAs (N_STA) may be a function of the bandwidth. A bandwidth interpretation may be used as in Table 5. The Trigger frame of other subvariants (e.g., Poll, Report, Threshold based results collection) may also comprise a Starting AID, instead of AID, to trigger a group of associated STAs or a group of unassociated STAs.

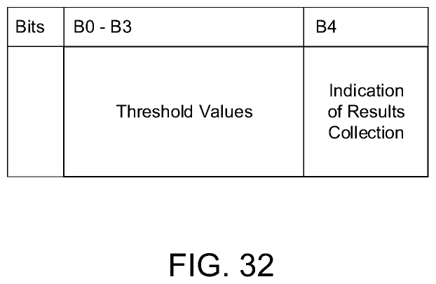

When the Sensing Trigger Subtype field value indicates that the Trigger frame is a Threshold based results collection subvariant (e.g. the Sensing Trigger Subtype field value=3), the Trigger frame may be used to collect CSI Threshold based sensing results (e.g., threshold about CSI variation), from multiple (associated or unassociated) STAs. A User Info field used for the Sensing Trigger frame of Report subvariant may be used in the Sensing Trigger frame of Threshold based results subvariant as shown in FIG. 32. The Trigger Dependent User Info subfield may comprise a threshold values subfield and an indication of results collection subfield. If the indication equals a first value (e.g., 1), then the CSI variations and the CSI values which have the variations larger than the threshold may be reported. If the indication equals a second value (e.g. 0), then only the CSI variations may be required to report. AID values included in the User Info field of the Trigger frame may be the AID address of the associated STA or the AID address of the unassociated STA. The actual bit number of each field, or subfield, in the Trigger frame may be changed.

In an embodiment, a sensing initiator may trigger concurrent sounding/sensing NDP PPDUs which has an EHT or a future version format from one or more sounding/sensing transmitters. An EHT variant trigger frame may be modified for this purpose.

In an embodiment, a new value of a Trigger Type subfield in a Common Info field in a Trigger frame may be used to indicate a Trigger frame which triggers NDP PPDUs. An exemplary Trigger Type subfield encoding is shown in Table 6. In this example, if the Trigger Type subfield is equal to a value of 9, it may indicate that the Trigger frame is used to trigger NDP sounding/sensing PPDUs.

TABLE 6
Example Trigger Type subfield encoding

| Trigger Type | |
|---|---|
| Subfield value | Trigger frame variant |
| 0 | Basic |
| 1 | BF Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll |
| | (BQRP) |
| 7 | NDP Feedback Report Poll |
| | (NFRP) |
| 8 | Ranging |
| 9 | NDP Sounding/Sensing Poll |
| 10-15 | Reserved |

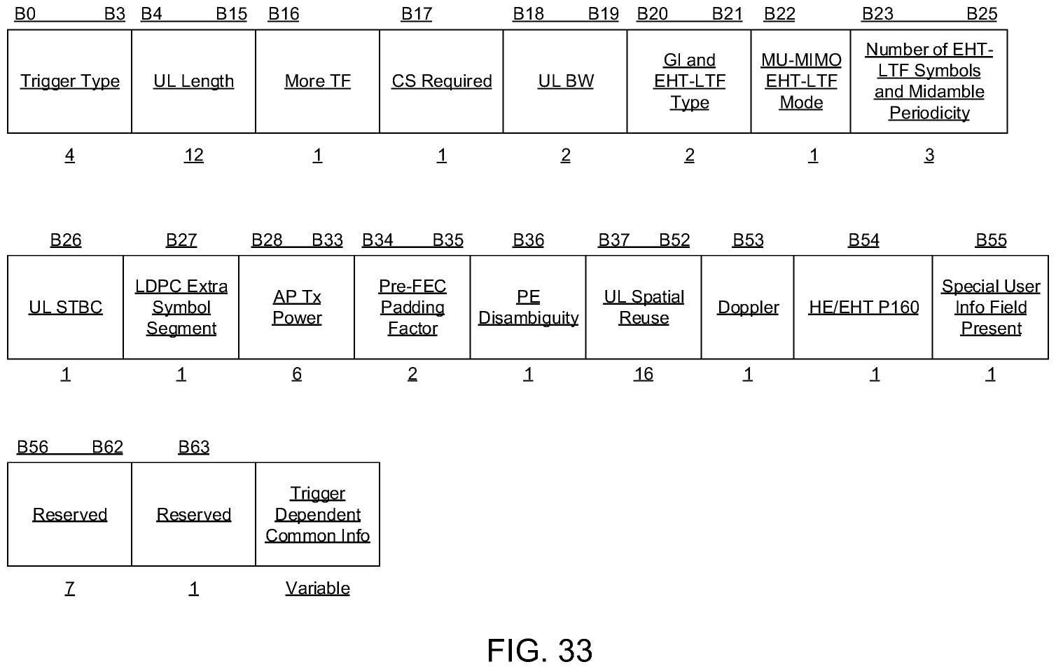

If the Trigger Type subfield indicates a NDP sounding/sensing poll, one or more subfields in an EHT variant Common Information field may have a different meaning, as shown in FIG. 33.

A Trigger Type subfield may have a new value to indicate NDP sounding/sensing poll. One or more of the 8 reserved bits may be used to set the Validate bits and Disregard bits in a U-SIG field in the NDP PPDU. The Number of EHT-LTF Symbols and Midamble Periodicity subfield may carry partial information about the number of EHT-LTF symbols in the NDP PPDU. The UL Length subfield may indicate the value of the L-SIG LENGTH field of the solicited NDP PPDU. The UL Length subfield may cover the duration from the end of the L-SIG field to the end of EHT-LTF field in the NDP PPDU.

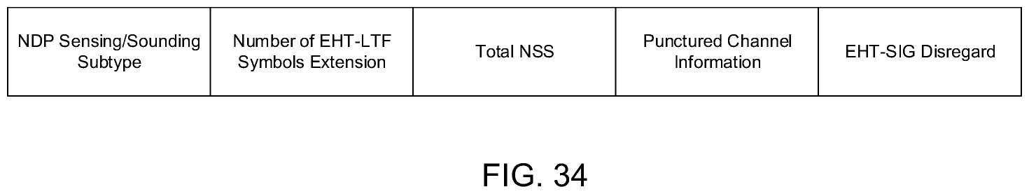

An example of Trigger Dependent Common Info subfields for an EHT variant Common Info field in a trigger frame is shown in FIG. 34. A Trigger Dependent Common Info subfield may comprise a NDP Sounding/Sensing Subtype subfield, which may indicate the detailed NDP sounding/sensing type. For example, it may indicate Non-orthogonal NDP, Concurrent NDP or Sequential NPD. For Non-orthogonal NDP, the NDP PPDUs polled or triggered may be used to support a procedure for Non-orthogonal sounding/sensing. The NDP PPDUs may be transmitted concurrently in a time/frequency/spatial domain and the NDP PPDUs from different STAs may not be distinguished. For Concurrent NDP, NDP PPDUs polled or triggered may be transmitted concurrently in a time domain but may be distinguished in a frequency domain or spatial domain (e.g. by P matrix). For Sequential NDP, NDP PPDUs polled or triggered may be transmitted sequentially in a time domain.

The Trigger Dependent Common Info subfield may comprise a Number of EHT-LTF Symbols Extension subfield. The receiving STAs may use this subfield and the EHT-LTF Symbols And Midamble Periodicity Subfield to determine the Number of EHT-LTF symbols in the NDP PPDU. The extension subfield may enable a larger number of EHT-LTF symbols and thus provide more accurate channel sounding/sensing results.

The Trigger Dependent Common Info subfield may comprise a Total NSS subfield, which may indicate a total number of spatial streams across all NDP transmissions from multiple STAs. This subfield may provide information for the receiving STA to copy and set the NSS field in an EHT-SIG field in the NDP PPDU.

The Trigger Dependent Common Info subfield may comprise a Punctured Channel Information subfield which may indicate the punctured channel information in the transmission. The receiving STA may save the value carried here in a RXVECTOR parameter INACTIVE_SUBCHANNEL or other parameter (e.g. newly defined parameter), and set the Punctured Channel Info field in the U-SIG field of NDP PPDU to the parameter.

The Trigger Dependent Common Info subfield may comprise an EHT-SIG Disregard subfield which may carry information for the receiving STA to copy and set the values to the Disregard field in the EHT-SIG in the responding NDP PPDU.

One or more of the fields mentioned above may be carried in other field(s) of the Trigger frame (e.g., Special User Info field or User Info field).

In an embodiment, a User Info field, UL MCS subfield, and UL DCM subfield may be reserved and/or have other meaning in the NDP sounding/sensing Trigger frame. For example, some bits in the field may be used to indicate an additional number of spatial streams besides an SS Allocation subfield.

In an embodiment, the UL Spatial Reuse subfields in a Common Info field and/or Spatial Reuse subfields in a Special User Info field may be set to the same value in the NDP sounding/sensing Trigger frame.

In an embodiment, the trigger frame may be used to trigger a NDP which may use an EHT TB PPDU format with a dummy data field (e.g., 1 data symbol or 2 data symbols). A TXVECTOR parameter L_LENGTH field of an EHT TB PPDU may have the same value as the UL Length subfield of the trigger frame. An example of Length may be a function of TXTIME. An example of TXTIME may be to include the time duration, duration of dummy data field, time for packet extension and signal extension, which may include T_RL_SIG, T_U_SIG, T_EHT_SIF-T, number of EHT LTF symbols and duration of EHT-LTF symbol. The dummy data field may include a fixed number of data symbols (e.g., 1 or 2 data symbols). The dummy data field may include a constant value (e.g., all zeros or a fixed sequence which may be known by the AP and the non-AP STA).

In an embodiment, an existing Trigger Type may be reused to trigger a NDP PPDU. For example, a NFRP Trigger frame may be used and modified. If the Trigger Type subfield in a Common Info field in the Trigger frame may indicate an NFRT Trigger, one or more subfields described herein may be present in the Trigger Dependent Common Info subfield in the Common Info field.

A Feedback subfield in a User Info field in the Trigger frame may be set to a new value to indicate the Feedback may be a NDP Sounding/Sensing PPDU. If the Feedback subfield indicates a Trigger frame which solicits NDP sounding/sensing response transmissions, the User Info field in the Trigger frame may be modified to carry one or more information described herein.

In an embodiment, an EHT NDP PPDU, which may carry a U-SIG field and an EHT-SIG field, may be used by a STA to respond to a Trigger frame with NDP Sounding Poll type. To set a U-SIG field, EHT-SIG field, and trigger-based transmission properly, the STAs which receive the Trigger frame that solicits NDP PPDUs may set TXVECTOR parameters. A FORMAT parameter may be set to EHT_MU or EHT_TB. The newly defined parameters, NDP_DISREGARD_IN_USIG, NDP_VALIDATE_IN_USIG1, NDP_VALIDATE_IN_USIG2, may be set to the value of U-SIG Disregard And Validate subfield in the Special User Info field in the Trigger frame. The receiving STA may set Disregard subfields and validate subfields in the U-SIG field in the NDP PPDU based on the parameters. The newly defined parameter, NDP_DISREGARD_IN_EHT, may be set to the value of EHT-SIG Disregard subfield in the Trigger frame. The receiving STA may set Disregard subfields in a EHT-SIG field in the NDP PPDU based on the parameter. The newly defined parameter, INACTIVE_SUBCHANNELS, may be set to the value of the Punctured Channel Information subfield. The MCS_EHT_SIG parameter may be set to 0. The NUM_EHT_SIG_SYMBOLS parameter may be set to 0. The NUM_HE_LTF (or NUM_EHT_LTF) parameter may be set to the value indicated by the Number Of HE-LTF Symbols And Midamble Periodicity subfield and Number of EHT-LTF

Symbols Extension subfield of the Common Info field of the Trigger frame. The newly defined parameter, NSS_TOTAL, may be set to the value indicated by the Total NSS subfield in the Trigger frame. The receiving STA may set the NSS subfield in EHT-SIG field based on the NSS_TOTAL parameter.

The STA which receives the Trigger frame and prepares the NDP transmission may set the EHT-SIG MCS field to 0 and the Number Of EHT-SIG Symbols field to 0 in the U-SIG field in the EHT NDP PPDU.

In an embodiment, an EHT TB PPDU, which may carry a U-SIG field and no Data field, may be used to respond to the Trigger frame with NDP Sounding Poll type. This type of PPDU may be referred to as EHT_TB Sounding NDP PPDU.

To set a U-SIG field and trigger-based transmission properly, the STAs which receive the Trigger frame that solicits NDP PPDUs may set the TXVECTOR parameters. The FORMAT parameter may be set to EHT_TB. The APEP_LENGTH parameter may be set to 0. If this field is set to 0 and the FORMAT is EHT_TB, it may indicate the transmitting PPDU is an EHT TB sounding NDP PPDU. The NUM_HE_LTF (or NUM_EHT_LTF) parameter may be set to the value indicated by the Number Of HE-LTF Symbols AND Midamble Periodicity subfield and Number of EHT-LTF Symbols Extension subfield of the Common Info field of the Trigger frame. The L_LENGTH parameter may cover a duration from the end of L-SIG to the end of the last EHT-LTF.

The EHT_TB Sounding NDP PPDU may have the following properties. The EHT_TB Sounding NDP PPDU may use the EHT TB PPDU format but without the Data field. The EHT_TB Sounding NDP PPDU may have a PE field that is M (μ s) in duration. For example, M may be 0, 4, 8, 12, 16. The LENGTH subfield in L-SIG field may be set to the TXVECTOR parameter L_LENGTH+2, which may indicate a duration from the end of L-SIG field to the end of the last EHT-LTF field.

A NDP announcement frame may be used in non-TB sensing and in the NDPA sounding phase of the TB sensing measurement instance to signal the attributes of the feedback the sensing receiver may measure for the NDP. Enhancing the NDPA to support different NDP formats, to enable TB and non-TB sensing, and to support collaborative sensing is needed.

In an embodiment, a Measurement Setup ID may identify a use case which may be characterized by a set of parameters or attributes such as a sensing bandwidth, a subcarrier grouping, a scaling factor, and any other relevant attribute. Table 7 shows an example design of an identification of different measurement setup use cases. In an example, as shown in Table 7, different use cases may be identified by the bandwidth, subcarrier grouping (Ng) and scale factor for which each use case may be identified by a Measurement Setup ID.

TABLE 7
Example Design of the Identification of
Different Measurement Setup Use Cases

| Measurement | Bandwidth | | Scale Factor |
|---|---|---|---|
| Setup ID | (MHz) | Ng | (3/6 bits) |
| 0 | Reserved | | |
| 1 | 20 | 2 | 0 |
| 2 | 20 | 2 | 1 |
| 3 | 20 | 4 | 0 |
| 4 | 20 | 4 | 1 |
| 5 | 20 | 8 | 0 |
| 6 | 20 | 8 | 1 |
| 7 | 20 | 16 | 0 |
| 8 | 20 | 16 | 1 |
| 9 | 20 | 64 | 0 |
| 10 | 20 | 64 | 1 |
| 11 | 40 | 2 | 0 |
| 12 | 40 | 2 | 1 |
| 13 | 40 | 4 | 0 |
| 14 | 40 | 4 | 1 |
| 15 | 40 | 8 | 0 |
| 16 | 40 | 8 | 1 |
| 17 | 40 | 16 | 0 |
| 18 | 40 | 16 | 1 |
| 19 | 40 | 64 | 0 |
| 20 | 40 | 64 | 1 |
| 21 | 80 | 2 | 0 |
| 22 | 80 | 2 | 1 |
| 23 | 80 | 4 | 0 |
| 24 | 80 | 4 | 1 |
| 25 | 80 | 8 | 0 |
| 26 | 80 | 8 | 1 |
| 27 | 80 | 16 | 0 |
| 28 | 80 | 16 | 1 |
| 29 | 80 | 64 | 0 |
| 30 | 80 | 64 | 1 |
| 31 | 160 | 2 | 0 |
| 32 | 160 | 2 | 1 |
| 33 | 160 | 4 | 0 |
| 34 | 160 | 4 | 1 |
| 35 | 160 | 8 | 0 |
| 36 | 160 | 8 | 1 |
| 37 | 160 | 16 | 0 |
| 38 | 160 | 16 | 1 |
| 39 | 160 | 64 | 0 |
| 40 | 160 | 64 | 1 |
| 41 | 320 | 2 | 0 |
| 42 | 320 | 2 | 1 |
| 43 | 320 | 4 | 0 |
| 44 | 320 | 4 | 1 |
| 45 | 320 | 8 | 0 |
| 46 | 320 | 8 | 1 |
| 47 | 320 | 16 | 0 |
| 48 | 320 | 16 | 1 |
| 49 | 320 | 64 | 0 |
| 50 | 320 | 64 | 1 |

In an embodiment, a Measurement Setup ID of each use case may be defined by a preferred or recommended set of parameters for each application scenario. Different applications may be associated with one or more sets of parameters which may be identified by a Measurement Setup ID. In an example, Table 8 provides different sets of attributes/parameters that may be recommended for the corresponding use case or application.

TABLE 8
Example Design of the Recommended Parameter
Set for Different Measurement Setup Use Cases

| | Recommended | Measurement |
|---|---|---|
| Use Case | Parameter Set | Setup ID |
| Reserved | Reserved | 0 |
| Room | BW = 20, Ng = 4, | 1 |
| Sensing | Scale Factor = 0 | |
| Room | BW= 40, Ng = 4, | 2 |
| Sensing | Scale Factor = 0 | |
| Room | BW = 80, Ng = 4, | 3 |
| Sensing | Scale Factor = 0 | |
| Room | BW = 80, Ng = 8, | 4 |
| Sensing | Scale Factor = 0 | |
| Aliveliness | BW = 20, Ng = 2, | 5 |
| detection | Scale Factor = 1 | |
| Aliveliness | BW = 40, Ng = 2, | 6 |
| detection | Scale Factor = 1 | |
| Aliveliness | BW = 80, Ng = 2, | 7 |
| detection | Scale Factor = 1 | |
| Aliveliness | BW = 80, Ng = 4, | 8 |
| detection | Scale Factor = 1 | |
| Smart meeting | BW = 80, Ng = 4, | 9 |
| room | Scale Factor = 0 | |
| Smart meeting | BW = 160, Ng = 8, | 10 |
| room | Scale Factor = 0 | |
| Smart meeting | BW = 320, Ng = 16, | 11 |
| room | Scale Factor = 1 | |
| Smart meeting | BW = 320, Ng = 64, | 12 |
| room | Scale Factor = 1 | |

In an embodiment, the Measurement Setup ID may be determined by the application type (or category) and/or the corresponding requirement(s). In other words, one application type (or category) with certain requirements may be mapped to one Measurement Setup ID. Table 9 shows an example measurement setup ID mapping table, where one application is mapped to one measurement setup ID. The number of measurement setup ID may be determined by the number of applications that will be applied in the sensing. The mapping between the application and the measurement setup ID may be changed, which does not necessarily follow Table 9. The sensing application may not be limited to that shown in Table 9.

TABLE 9
Example Measurement Setup ID Mapping Table

| | | | | Max | | |
|---|---|---|---|---|---|---|
| | | | | Velocity | | |
| | | Max | Range | (m/s)/ | Angular | |
| | | range | Accuracy | Velocity | Accuracy | Measurement |
| Application Name | Details | (m) | (m) | Accuracy | (deg) | Setup ID |
| Room Sensing | Presence | 15 | 0.5-2 | 2/0.1 | | 0 |
| | detection, | | | | | |
| | counting the | | | | | |
| | number of | | | | | |
| | people in the | | | | | |
| | room | | | | | |
| Smart meeting room | Presence | 10 | 0.5-2 | 1/0.1-0.3 | | 1 |
| | detection, | | | | | |
| | counting the | | | | | |
| | number of | | | | | |
| | people in the | | | | | |
| | room, | | | | | |
| | localization of | | | | | |
| | active people | | | | | |
| Motion detection in a | Detection of | 10 | | | | 2 |
| room | motion of in a | | | | | |
| | room (of | | | | | |
| | Human) | | | | | |
| Home security | Detection of | 10 | 0.5-2 | 3/0.1-0.3 | Medium | 3 |
| | presence of | | | | | |
| | intruders in a | | | | | |
| | home | | | | | |
| Audio with user | Tracking | 6 | 0.2 | 0.5/0.05 | 3 | 4 |
| tracking | persons in a | | | | | |
| | room and | | | | | |
| | pointing the | | | | | |
| | sound of an | | | | | |
| | audio system | | | | | |
| | at those | | | | | |
| | people | | | | | |
| Store Sensing | Counting | 20 | 0.5-2 | 1/0.1-0.3 | 3 | 5 |
| | number of | | | | | |
| | people in a | | | | | |
| | store, their | | | | | |
| | location, | | | | | |
| | speed of | | | | | |
| | movement. | | | | | |
| | Accuracy less | | | | | |
| | important | | | | | |
| Home Appliance | Tracking | 10 | <1 | | | 6 |
| Control | person and | | | | | |
| | motion/ | | | | | |
| | gesture | | | | | |
| | detection | | | | | |
| Gesture recognition - | Identification | 0.5 | | 7 | 3 | 7 |
| short range (finger | of a gesture | | | | | |
| movement) | from a set of | | | | | |
| | gestures - | | | | | |
| | range <0.5 m | | | | | |
| Gesture recognition - | Identification | 2 | | | | 8 |
| medium range (hand | of a gesture | | | | | |
| movement) | from a set of | | | | | |
| | gestures - | | | | | |
| | range >0.5 m | | | | | |
| Gesture recognition - | Identification | 7 | 0.2 | 2/0.1 | 5 | 9 |
| large range (full body | of a gesture | | | | | |
| movement) | from a set of | | | | | |
| | gestures - | | | | | |
| | range >2 m | | | | | |
| Aliveliness detection | Determination | 1 | 0.05 | | | 10 |
| | whether a | | | | | |
| | close by object | | | | | |
| | is alive or not | | | | | |
| Face/Body Recognition | Selection of | 1 | 0.02 | | | 11 |
| | the identity of | | | | | |
| | a person from | | | | | |
| | a set of known | | | | | |
| | persons | | | | | |
| Proximity Detection | Detection of | 0.5 | 0.02-2 | 1.5/0.2 | none | 12 |
| | object in close | | | | | |
| | proximity of | | | | | |
| | device | | | | | |
| Home Appliance | Gesture | 3 | <1 | 3/0.1 | | 13 |
| Control | Detection | | | | | |
| Health care - Fall | Fall detection - | 10 | 0.2 | 3/0.1 | | 14 |
| detection | abnormal | | | | | |
| | position | | | | | |
| | detection | | | | | |
| Health case - remote | Measurements | 5 | 0.5 | 2/0.1 | | 15 |
| diagnostics | of breathing | | | | | |
| | rate, heart rate | | | | | |
| | etc. | | | | | |
| Surveillance/Monitoring | Tracking | 10 | 0.2-2 | 3/0.1 | | 16 |
| of elder people and/or | person and | | | | | |
| children | presence | | | | | |
| | detection | | | | | |
| Sneeze sensing | Detecting and | 10 | 0.2-0.5 | 20/0.1 | | 17 |
| | localizing the | | | | | |
| | target human | | | | | |
| | and sneeze | | | | | |
| | droplet volume | | | | | |
| 3D vision | Building a 3D | 10 | 0.01 | 5/0.1 | 2 | 18 |
| | picture of an | | | | | |
| | environment, | | | | | |
| | using multiple | | | | | |
| | STA | | | | | |
| In car sensing - | Detection of | 5 | 0.1 | 1/0.1 | 3 | 19 |
| detection | humans in car | | | | | |
| In car sensing | Driver | 3 | 0.01 | 1/0.1 | 3 | 21 |
| | sleepiness | | | | | |
| | detection/ | | | | | |
| | detection aid | | | | | |

In an embodiment, the measurement setup ID may be negotiated in the procedure of the sensing measurement setup. The sensing initiator may assign one measurement setup ID to this sensing measurement setup. In a trigger based (TB) measurement setup where the sensing initiator is the AP, the sensing responder (non-AP STA) may accept or reject the measurement setup ID which may be indicated in a Sensing Measurement Parameters Element in the Sensing Measurement Setup Request frame, or suggest another measurement setup ID. In a non-TB measurement setup where the sensing initiator is the non-AP STA, the sensing responder (AP) may accept or reject the measurement setup ID which may be indicated in the Sensing Measurement Parameters Element in the Sensing Measurement Setup Request frame, or suggest another measurement setup ID or demand another measurement setup ID (e.g., only accept the measurement ID indicated in the responding frame). The suggested or demanded measurement setup ID may be indicated in the Sensing Measurement Parameters Element in the Sensing Measurement Setup Response frame.

In an embodiment, a sensing NDPA may include one or more Special STA Info fields for different purposes. In an example, a Special STA Info field may be used to carry the common information of a TB sensing measurement instance as shown in Table 10. The subfields of the Special NDPA Info field may comprise one or more of: an AID11 subfield with a specific ID which may indicate a purpose of the Special STA Info field, a measurement setup ID (MSI) subfield to signal the Measurement Setup ID for which this TB sensing is taking place, a measurement instance ID (MII) subfield to signal the Measurement Instance ID for the identification of the TB measurement instance, a Version subfield to indicate that this NDPA is for sensing and may also indicate future sensing amendments, a Disambiguation subfield; a More Special subfield to signal if there are more Special STA Info field in the NDPA frame, and a NDP Format subfield to indicate which format is used to send the NDP immediately after the NDPA. The NDP format may include HT NDP, VHT NDP, HE NDP, HE Ranging NDP, HE TB Ranging NDP, EHT Sounding NDP, EHT Sensing NDP, EHT TB NDP or any newly defined NDP format for the purpose of sensing or channel measurements in general.

TABLE 10
Example Design of a Special STA Info to carry the common
information of the TB sensing measurement instance

| | | | | | | | |
|---|---|---|---|---|---|---|---|
| AID11 | MSI | MII | Version | Disambiguation | NDP | Reserved | More |
| | | | | | Format | | Special |

In an embodiment, two or more Special User Info fields may exist in a NDPA frame to signal different Measurement Setup attributes or parameters in the same NDPA for different set of STAs as shown in Table 11. Special STA Info 1 may signal a set of attributes or parameters corresponding to a use case or an application and Special STA Info 2 may signal another set of attributes or parameters corresponding to a different use case in which each use case may be identified by a different Measurement Setup ID.

TABLE 11
Example Design of NDPA with Multiple Special STA Info fields

| Frame | Duration | RA | TA | Sounding | Special | STA | . . . | STA | Special | STA | . . . | STA |
|---|---|---|---|---|---|---|---|---|---|---|---|---|
| Control | | | | Dialog | STA | Info | | Info | STA | Info | | Info |
| | | | | Token | Info 1 | 1 | | n | Info 2 | n + 1 | | m |

In an embodiment, the sensing receiver that receives the Sensing NDPA may identify that the received NDPA is a Sensing NDPA using different methods. In an example, the sensing receiver may decode the Sounding Dialog Token in which an indication of the Sensing NDPA variant may be provided. In another example, the sensing receiver may look for a Special STA Info field with a specific AID which may indicate that the NDPA is a Sensing NDPA variant. In another example, the Version subfield of the Special STA Info field may indicate that the NDPA is for Sensing and may provide more information about which version of a sensing feature is supported for forward compatibility and future amendments of sensing. The sensing receiver may check the More Special subfield of the first Special STA Info field. If the More Special is set to a value (e.g. 1), this may indicate that the NDPA includes another Special STA Info field or otherwise the first Special STA Info field may be the only one in the current NDPA. If the NDPA includes more than one Special STA Info field, then the sensing receiver may follow the signaling settings and attributes of the Special STA Info field immediately preceding its own STA Info field in the NDPA if it is included.

In an embodiment, the format of the STA Info field in a Sensing NDPA may follow a design as shown in Table 12.

TABLE 12
Example Design of STA Info field of Sensing NDPA

| | | | | | | | | |
|---|---|---|---|---|---|---|---|---|
| AID11 | Collaborative_{—} | IT2RR_{—} | IT2RR_{—} | RT2IR_NSS/ | RT2IR_LTF_Rep/ | Disambiguation | RT2RR | Reserved |
| | Responder | NSS | LTF_{—} | RT2RR_NSS | RT2RR_LTF_Rep | | NDP Tx | |
| | | | Rep | | | | Power | |

The subfields of the STA Info field may comprise a Collaborative_Responder subfield which may indicate that the STA Info field is for a sensing responder that may participate in a collaborative sensing session. One or more bits may be used to encode the different Collaborative_Responder role variants in a collaborative sensing session. In an example, Table 13 shows a 2-bit encoding of the Collaborative_Responder subfield. If the Collaborative_Responder is set to 00, the STA Info field may be intended to a STA that may act as a regular responder which may receive the NDP sent by the initiator transmitter and prepare the CSI for the channel between this initiator and itself. If the Collaborative_Responder is set to 01, the STA Info field may be intended to a STA that may act as a collaborative responder transmitter and may send an NDP based on the parameters of this STA Info field. If the Collaborative_Responder is set to 10, the STA Info field may be intended to a STA that may act as a collaborative responder receiver and may measure the CSI between the sensing initiator transmitter and itself based on the NDP sent from the initiator and may also measure the CSI between the collaborative responder transmitter and itself based on the NDP sent from the collaborative responder transmitter.

TABLE 13
Example 2-bit Encoding of the Collaborative_Responder subfield

| Collaborative_Responder | Collaborative_Responder |
|---|---|
| subfield value | Role |
| 00 | Regular Responder |
| 01 | CR_Tx (Collaborative |
| | Responder transmitter) |
| 10 | CR_Rx (Collaborative |
| | Responder receiver) |
| 11 | Reserved |

An IT2RR_NSS subfield of the STA Info field may indicate a number of transmit antenna which may be used to transmit the NDP from the sensing initiator transmitter (IT) to the sensing responder receiver (RR) in an NDPA sounding phase of a TB sensing measurement instance or in a non-TB sensing measurement instance.

An IT2RR_LTF_Rep subfield of the STA Info field may indicate a number of repetitions of the LTFs of the NDP sent from the sensing initiator transmitter (IT) to the sensing responder receiver (RR) in an NDPA sounding phase of a TB sensing measurement instance or in a non-TB sensing measurement instance such that a particular value (e.g. 0) may indicate no repetitions (i.e., an LTF is included once per the NDP) and other values may map to or associate with a certain number of repetitions.

An RT2IR_NSS subfield of the STA Info field may indicate a number of transmit antennas which may be used to transmit the NDP from the sensing responder transmitter (RT) to the sensing initiator receiver (IR) in a TF sounding phase of a TB sensing measurement instance or in a non-TB sensing measurement instance.

An RT2IR_LTF_Rep subfield of the STA Info field may indicate a number of repetitions of the LTFs of the NDP sent from the sensing responder transmitter (RT) to the sensing initiator receiver (IR) in a TF sounding phase of a TB sensing measurement instance or in a non-TB sensing measurement instance such that a particular value (e.g. 0) may indicate no repetitions (i.e., an LTF is included once per the NDP) and other values may map to or associate with a certain number of repetitions.

An RT2RR_NSS subfield of the STA Info field may indicate a number of transmit antennas which may be used to transmit the NDP from the sensing responder transmitter (RT) to the sensing responder receiver (RR) in a collaborative sensing measurement instance of an NDPA sounding phase or a TF sounding phase of a TB sensing measurement instance.

An RT2RR_LTF_Rep subfield of the STA Info field may indicate the number of repetitions of the LTFs of the NDP sent from the sensing responder transmitter (RT) to the sensing responder receiver (RR) in a collaborative sensing measurement instance of an NDPA sounding phase or a TF sounding phase of a TB sensing measurement instance. A particular value (e.g. 0) for this subfield may indicate no repetitions (i.e., an LTF is included once per the NDP) and other values may map to or associate with a certain number of repetitions.

An RT2RR NDP Tx Power subfield of the STA Info field may indicate the transmit power of the combined average power per 20 MHz bandwidth referenced to the antenna connector, of all antennas used to transmit the following RT2RR NDP from the sensing responder transmitter (RT) to the sensing responder receiver (RR) in a collaborative sensing measurement instance of an NDPA sounding phase or a TF sounding phase of a TB sensing measurement instance.

In an embodiment, a STA participating in a TB sensing measurement instance may act as a collaborative responder (CR). There may be one or more collaborative responder transmitters and one or more collaborative responder receivers. The collaborative responders, participating in an NDPA sounding phase of a TB sensing measurement instance, may be given the sensing role of a receiver (denoted as CR-Rx) or the sensing role of a transmitter and receiver (denoted as CR-TxRx) during the sensing measurement setup negotiation. The collaborative responders, participating in a TF sounding phase of a TB sensing measurement instance, may be given the sensing role of a transmitter (denoted as CR-Tx) or the sensing role of a transmitter and receiver (denoted as CR-TxRx) during the sensing measurement setup negotiation.

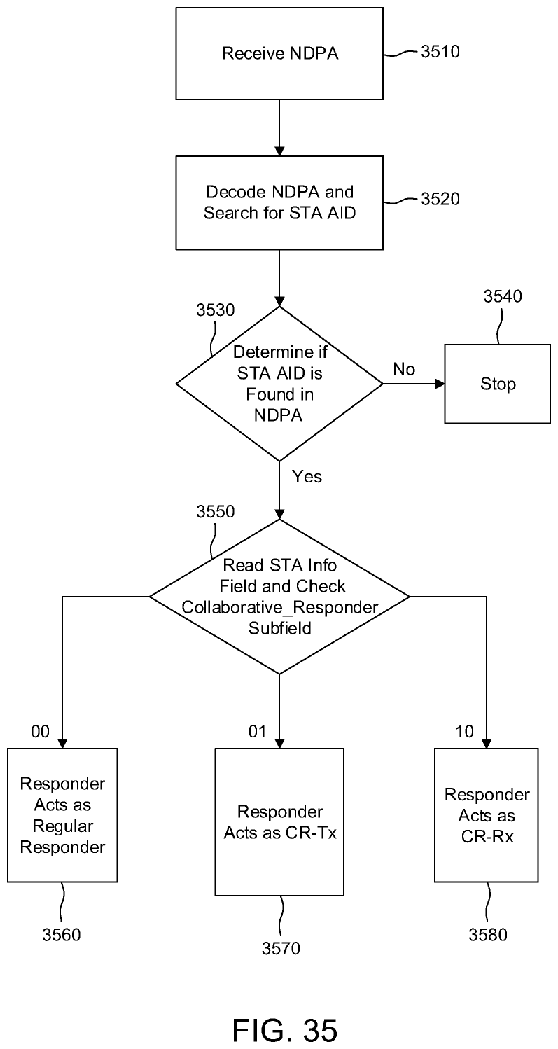

In an embodiment, the behavior of a responder participating in an NDPA sounding phase of a TB sensing measurement instance and performing a collaborative sensing procedure may be defined as indicated in FIG. 35.

A responder STA may receive an NDPA (3510). The responder STA may decode the STA Info fields of the NDPA and may search for its own STA association ID (AID) (3520). The STA may determine if the STA AID is found in the NDPA (3530). If the responder STA does not find its STA AID, the responder may stop decoding (3540). If the responder STA finds a STA Info field with its STA AID, the responder STA may decode the Collaborative_Responder subfield to identify which role it may play based on the different roles defined such as in Table 13 (3550).

(e.g. If the Collaborative_Responder subfield indicates a regular responder Collaborative_Responder subfield value is equal to a particular value such as “00”), the responder STA may act as a regular responder and may measure a CSI using the NDP sent by the initiator transmitter STA (3560).

If the Collaborative_Responder subfield indicates a CR_Tx (Collaborative Responder transmitter) (e.g. Collaborative_Responder subfield value is equal to a particular value such as “01”), the responder STA may act as a CR-Tx and may transmit an NDP based on parameters signaled in the STA Info field (3570).

If the Collaborative_Responder subfield indicates a CR_Rx (Collaborative Responder receiver) (e.g. Collaborative_Responder subfield value is equal to a particular value such as “10”), the responder STA may act as a CR-Rx and may receive the NDP sent by the initiator transmitter STA and may measure a CSI and may receive the NDP sent by the CR_Tx and measure another CSI (3580).

In an embodiment, a STA may support the participation in a collaborative sensing session. The STA may declare this capability in a sensing capability information element or sensing parameters element or any other element that may carry such information. The STA may support acting as a CR-Tx or a CR-Rx, or both. In an embodiment, the Collaborative_Responder may be set to a reserved value in the non-TB sensing measurement instances.

A Directional Multi-Gigabit (DMG) sensing measurement setup element and a sensing measurement parameters element may be included together in a sensing measurement setup request frame, for example as in 802.11bf. However, there is no indication to show that the sensing measurement setup request or the sensing measurement setup response is for a regular sensing measurement setup or for a DMG sensing measurement setup. Therefore, there is a need to improve the signaling efficiency related to DMG sensing measurement setup.

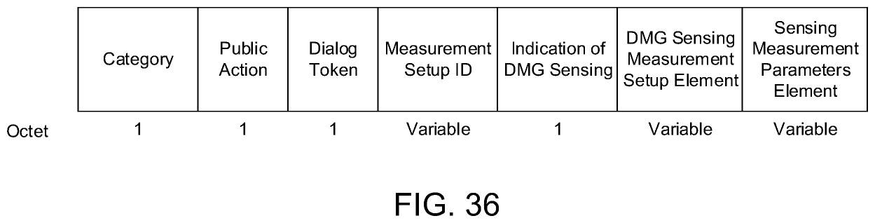

In an embodiment, a STA may receive a sensing measurement setup request (or response) frame. The STA may determine whether the sensing measurement setup request (or response) frame is for regular sensing or DMG sensing. In an embodiment, an indicator (e.g., using one bit) may be included in a sensing measurement setup request frame to indicate if the sensing measurement setup request/response is for a DMG sensing measurement setup or a regular sensing measurement. FIG. 36 shows an example of an Enhanced Sensing Measurement Setup Request frame action field format with the addition of an Indication of DMG Sensing subfield. If the Indication of DMG Sensing subfield is set to a particular value, for example ‘1’, then it may indicate that this frame is to request a DMG sensing measurement setup, which may mean that the recipient of this frame may ignore the value shown in the Sensing Measurement Parameters Element and may read the contents of the DMG Sensing Measurement Setup Element. If the Indication of DMG Sensing subfield is set to a different value, for example ‘0’, then it may indicate that this frame is to request a regular sensing measurement setup, which may mean that the recipient of this frame may ignore the value shown in the DMG Sensing Measurement Setup Element and may read the contents of the Sensing Measurement Parameters Element. A similar design may be applied to the Sensing Measurement setup Response frame Action field or other frame.

The Indication of DMG Sensing subfield may be removed from the Sensing Measurement Setup Request frame Action field. The Measurement Setup ID subfield may be used as an implicit indictor to indicate the DMG sensing measurement setup. For example, a certain range of measurement setup ID may represent the DMG sensing measurement and another range of measurement setup ID may represent the regular sensing measurement. In other words, when any value shown in the range of the measurement setup ID related to DMG sensing measurement is indicated in the Measurement Setup ID subfield, then the recipient of the Sensing Measurement Setup Request frame may read the information from the DMG Sensing Measurement Setup Element subfield and may ignore the contents in the Sensing Measurement Parameters Element subfield. When any value shown in the range of the measurement setup ID related to (non-DMG) sensing measurement is indicated in the Measurement Setup ID subfield, then the recipient of the Sensing Measurement Setup Request frame may ignore the contents in the DMG Sensing Measurement Setup Element subfield and read the information in the Sensing Measurement Parameters Element subfield. A similar design may be applied to a Sensing Measurement Setup Response frame Action field or other frame.

In an embodiment, Public Action fields may be defined for DMG sensing. Table 14 shows an example of Public Action field values of DMG sensing.

TABLE 14
Example Public Action field values of DMG Sensing

| Public Action field value | Description |
|---|---|
| <Last assigned + 1> | DMG Sensing Measurement Setup |
| | Request |
| < Last assigned + 1> | DMG Sensing Measurement Setup |
| | Response |
| < Last assigned + 1> | DMG Sensing Measurement Report |
| < Last assigned + 1> | DMG Sensing Setup Termination |

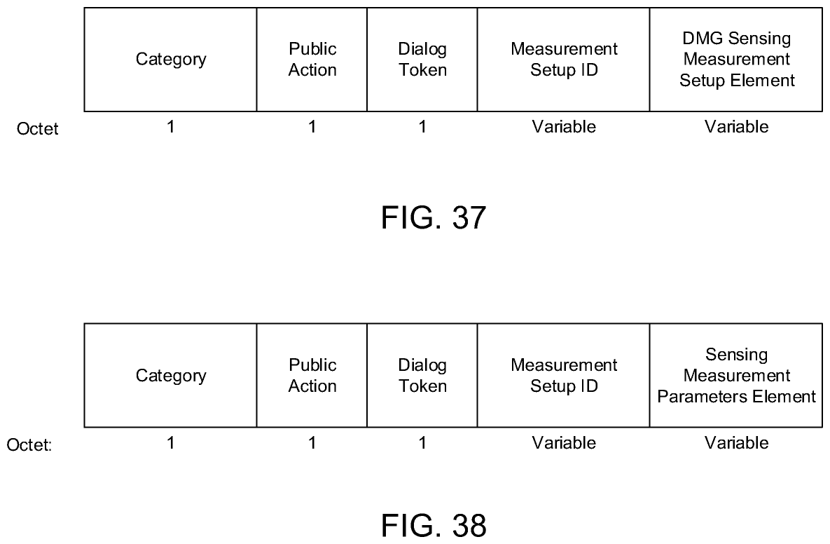

In this case, when a DMG Sensing related action is indicated, the recipient of the Sensing Measurement Setup Request frame may read the information indicated in the DMG Sensing Measurement Setup Element subfield and ignore the contents in the Sensing Measurement Parameters Element. When Sensing Measurement related actions are indicated (not DMG Sensing Measurement related actions), the recipient of the Sensing Measurement Setup Request frame may ignore the contents in the DMG Sensing Measurement Setup Element subfield and read the information shown in the Sensing Measurement Parameters Element. Similar logic may be applied to the Sensing Measurement Setup Response frame Action field or other frame. A DMG Sensing Measurement Setup Request frame Action field and Sensing Measurement Setup Request frame Action field may be separately defined. An example of a DMG Sensing Measurement Setup Request frame Action field is shown in FIG. 37. The DMG Sensing Measurement Setup Request frame Action field may comprise a Category subfield, a Public Action subfield, a Dialog Token subfield, a Measurement Setup ID subfield, and a DMG Sensing Measurement Setup Element subfield. An example of an Enhanced Sensing Measurement Setup Request frame Action field is shown in FIG. 38. The Enhanced Sensing Measurement Setup Request frame Action field may comprise a Category subfield, a Public Action subfield, a Measurement Setup ID subfield, and a Sensing Measurement Parameters Element subfield. When the Public Action field value indicates a DMG Sensing Measurement Setup Request, the DMG Sensing Measurement Setup frame Action field format, (e.g. as shown in FIG. 37), may be used. When the Public Action field value indicates a Sensing Measurement Setup Request, the Enhanced Sensing Measurement Setup frame Action field format, (e.g. as shown in FIG. 38), may be used. A similar design may be applied to DMG related action values, (e.g., DMG Sensing Measurement Setup Response, DMG Sensing Measurement Report and DMG Sensing Setup Termination).

In WLAN sensing, collaborative sensing refers to a scenario where a sensing responder may measure a NDP transmitted by another sensing responder. A collaborative sensing procedure may require an indication of a capability to perform collaborative sensing, control of the transmission of the NDP and measurement of the CSI, and enabling the sending of a feedback report. Support of collaborative sensing using a Trigger Frame is needed.

In an embodiment, a sensing initiator AP may identify the responders with a collaborative sensing capability implemented from a Sensing Capabilities Element or an Extended Capabilities Element or any Element that may indicate the capabilities of the STAs participating in the sensing session.

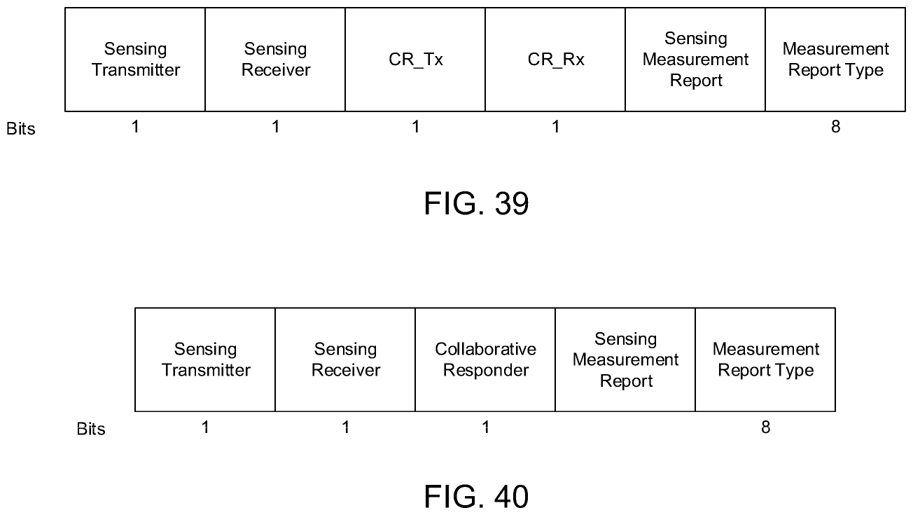

In an embodiment, the sensing initiator (e.g. AP) may assign to the responders with collaborative sensing capability a collaborative responder transmitter role (e.g. CR_Tx), a collaborative responder receiver role (e.g. CR_Rx), or a collaborative responder transmitter and receiver role (e.g. CR_TxRx). FIG. 39 shows an example design of the Sensing Measurement Parameters field format with two new subfields added: CR_Tx and CR_Rx. The CR_Tx subfield may be set to a value (e.g. ‘1’) to indicate a collaborative responder transmitter role for a sensing responder corresponding to this sensing measurement setup and may be set to a different value (e.g. ‘0’) otherwise. The CR_Rx subfield may be set to a value (e.g. ‘1’) to indicate a collaborative responder receiver role for a sensing responder corresponding to this sensing measurement setup and may be set to a different value (e.g. ‘0’) otherwise. The CR_Tx and CR_Rx may be both set to a same value (e.g. ‘1’) to indicate a collaborative responder transmitter and receiver role for a sensing responder corresponding to this sensing measurement setup. The CR_Tx and CR_Rx subfields may be set both to a same value (e.g. ‘0’) to indicate that the sensing responder corresponding to this sensing measurement setup is neither a collaborative responder transmitter nor a collaborative responder receiver. The CR_Tx and CR_Rx subfields may be set both to a same value (e.g. ‘0’) if the responder corresponding to this sensing measurement setup is participating in the current sensing measurement setup as a regular responder and not a collaborative responder or if this responder does not support collaborative sensing. Table 15 shows an example role setting based on the Sensing Measurement Parameters field format design I as shown in FIG. 39.

TABLE 15
Example Role Setting I in Sensing Measurement Setup

| Sensing | Sensing | | | |
|---|---|---|---|---|
| Transmitter | Receiver | CR_Tx | CR_Rx | Role |
| 0 | 0 | 0 | 0 | Not Allowed |
| 0 | 0 | 1 | 0 | Collaborative Responder Transmitter |
| 0 | 0 | 0 | 1 | Collaborative Responder Receiver |
| 0 | 0 | 1 | 1 | Collaborative Responder Transmitter and |
| | | | | Receiver |
| 1 | 0 | 0 | 0 | Regular Responder Transmitter |
| 1 | 0 | 1 | 0 | Regular Responder Transmitter and Collaborative |
| | | | | Responder Transmitter |
| 1 | 0 | 0 | 1 | Regular Responder Transmitter and Collaborative |
| | | | | Responder Receiver |
| 1 | 0 | 1 | 1 | Regular Responder Transmitter and Collaborative |
| | | | | Responder Transmitter and Receiver |
| 0 | 1 | 0 | 0 | Regular Responder Receiver |
| 0 | 1 | 1 | 0 | Regular Responder Receiver and Collaborative |
| | | | | Responder Transmitter |
| 0 | 1 | 0 | 1 | Regular Responder Receiver and Collaborative |
| | | | | Responder Receiver |
| 0 | 1 | 1 | 1 | Regular Responder Receiver and Collaborative |
| | | | | Responder Transmitter and Receiver |
| 1 | 1 | 0 | 0 | Regular Responder Transmitter and Receiver |
| 1 | 1 | 1 | 0 | Regular Responder Transmitter and Receiver and |
| | | | | Collaborative Responder Transmitter |
| 1 | 1 | 0 | 1 | Regular Responder Transmitter and Receiver and |
| | | | | Collaborative Responder Receiver |
| 1 | 1 | 1 | 1 | Regular Responder Transmitter and Receiver and |
| | | | | Collaborative Responder Transmitter and |
| | | | | Receiver |

In an embodiment, FIG. 40 shows an example design of the Sensing Measurement Parameters field format with one new subfield added. The newly added subfield may be named as Collaborative Responder and may be set to a value (e.g. ‘1’) to indicate a collaborative responder role or may be set to a different value (e.g. ‘0’) if the responder is participating in the current sensing measurement setup as a regular responder and not a collaborative responder or if the responder does not support collaborative sensing. The Collaborative Responder and the Sensing Transmitter subfields may be both set to a same value (e.g. ‘1’) to indicate a collaborative sensing transmitter role for a sensing responder corresponding to this sensing measurement setup. The Collaborative Responder and the Sensing Receiver subfields may be set both to a same value (e.g. ‘1’) to indicate a collaborative sensing receiver role for a sensing responder corresponding to this sensing measurement setup. The Collaborative Responder, the Sensing Transmitter, and the Sensing Receiver subfields may be all set to a same value (e.g. ‘1’) to indicate a collaborative sensing transmitter and receiver role for a sensing responder corresponding to this sensing measurement setup. Table 16 shows an example role setting based on the Sensing Measurement Parameters field format design II as shown in FIG. 38. A case where the Sensing Transmitter role is set to 0 and Sensing Receiver role is set to 0 may be not allowed.

TABLE 16
Example Role Setting II in Sensing Measurement Setup

| Sensing | Sensing | Collaborative | |
|---|---|---|---|
| Transmitter | Receiver | Responder | Role |
| 1 | 0 | 1 | Collaborative Responder |
| | | | Transmitter |
| 0 | 1 | 1 | Collaborative Responder |
| | | | Receiver |
| 1 | 1 | 1 | Collaborative Responder |
| | | | Transmitter and Receiver |
| 1 | 0 | 0 | Regular Responder |
| | | | Transmitter |
| 0 | 1 | 0 | Regular Responder |
| | | | Receiver |
| 1 | 1 | 0 | Regular Responder |
| | | | Transmitter and Receiver |
| 0 | 0 | 1 | Not Allowed |
| 0 | 0 | 0 | Not Allowed |

In an embodiment, a Sensing Sounding Trigger frame may be used to solicit an NDP transmission from the sensing responders such that other sensing responders that are assigned the sensing role of collaborative receiver may measure the NDP and may report feedback of the measurement to the AP sensing initiator in a TB sensing measurement instance.

In an embodiment, the Sensing Trigger Subtype subfield of the Trigger Dependent Common Info subfield of the Sensing Trigger variant as shown in FIG. 27 may comprise a variant which may take a value (e.g. 5) and indicate that the sensing measurement setup is a collaborative sensing measurement as shown in Table 17.

TABLE 17
Example Sensing Trigger Subtype subfield

| Sensing Trigger Subtype field value | Sensing Trigger frame subvariant |
|---|---|
| 0 | Poll |
| 1 | NDP Soliciting |
| 2 | Report |
| 3 | Threshold based result collection |
| 4 | Group NDP Soliciting |
| 5 | Collaborative Sensing |
| 6-15 | Reserved |

In an embodiment, an AP may configure a solicited NDP in a TF sounding phase of a TB sensing measurement instance such that the number of repetitions of the Responder-to-Responder (R2R)-NDP to be used for collaborative sensing is the same as the number of repetitions of the Responder-to-Initiator (R21)-NDP to be used in regular sensing. In this scenario, the CR-Rx participating in this sending TF sounding phase of the TB sensing measurement instance may use the subfield R21 Rep in the User Info field of the Sounding subvariant of the Sensing Trigger frame to learn how many repetitions the LTFs will be repeated in the solicited NDP.

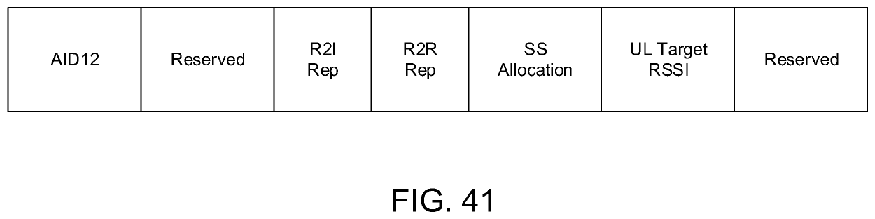

In an embodiment, an AP may configure a solicited NDP in a TF sounding phase of a TB sensing measurement instance such that the number of repetitions of the Responder-to-Responder (R2R)-NDP to be used for collaborative sensing is different from the number of repetitions of the Responder-to-Initiator (R21)-NDP to be used in regular sensing. In this scenario, the sensing responder may transmit an NDP with the number of repetitions indicated in the R21 Rep subfield of the User Info field as shown in FIG. 41. This NDP may be received by the AP sensing initiator to measure the sensing feedback. After a SIFS from transmitting the first NDP, the responder may then transmit another NDP with the number of repetitions indicated in the R2R Rep subfield of the User Info field as shown in FIG. 41. This NDP may be received by the collaborative sensing receivers to measure the sensing feedback.

In an embodiment, the collaborative responder receiver (CR_Rx) may receive the NDP transmitted by the sensing transmitter in the TF sounding phase of the TB sensing measurement instance and measure the CSI. The CR_Rx may then prepare the feedback and send it directly to the AP when the AP sends the Reporting trigger frame. In an embodiment, the CR_Rx may send the feedback to a responder with the role sensing transmitter and receiver which may then aggregate this feedback with the feedback it measured in this sensing instance or previous sensing instances and then send it to the AP when the AP sends the Reporting trigger frame.

Although the features and elements of the present disclosure are described in the preferred embodiments in particular combinations, each feature or element can be used alone without the other features and elements of the preferred embodiments or in various combinations with or without other features and elements of the present disclosure.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval may be applied in the same solutions.

Although four RBs per triggered TXOP are shown in some figures as example, the actual number of RBs/channels/bandwidth utilized may vary.

Although specific bits are used to signal in-BSS/OBSS as example, other bit may be used to signal this information.

Although some Trigger Type values are used as examples to identify newly defined trigger frame variants, other values may be used.

Multi-AP and MAP may be used interchangeably and may refer to the same concept.

Long Training Field (LTF) may be any type of predefined sequences that are known at both transmitter and receiver sides.

Some of the figures show a number of bits or bit positions but are shown as examples and it is understood that the bit positions and number of bits may be different.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for wireless local area network (WLAN) sensing, for a station (STA), the method comprising:
receiving a trigger frame, wherein the trigger frame comprises at least a common information field, wherein the common information field comprises at least a trigger type subfield and a trigger dependent common information subfield, wherein the trigger dependent common information subfield comprises sensing subfields, wherein the sensing subfields are based on a value of the trigger type subfield; and
sending a trigger response frame, wherein a format of the trigger response frame is at least based on at least one of the sensing subfields of the trigger dependent common information subfield.

2. The method of claim 1, wherein the trigger frame further comprises a user information field, wherein the user information field comprises a trigger dependent user information subfield, wherein the trigger dependent user information subfield comprises at least a threshold value subfield and an indication of results collection subfield.

3. The method of claim 2, wherein information in the trigger response frame is at least based on the threshold value subfield and the indication of results collection subfield.

4. The method of claim 1, wherein the value of the trigger type subfield indicates a ranging trigger frame variant or a null data packet (NDP) sounding poll trigger frame variant.

5. The method of claim 4, wherein on a condition that the value of the trigger type subfield value indicates a ranging trigger frame variant, the sensing subfields of the trigger dependent common information subfield comprise at least one of: a sensing trigger subtype subfield, a measurement setup identification (MSI) subfield, a measurement instance identification (MII) subfield, or a session setup identification subfield.

6. The method of claim 5, wherein the sensing trigger subtype subfield comprises information indicating a sensing trigger frame subvariant, wherein the sensing trigger frame subvariant comprises one of: poll, null data packet (NDP) soliciting, report, threshold based result collection, or group NDP soliciting.

7. The method of claim 4, wherein on a condition that the value of the trigger type subfield indicates a NDP sounding poll trigger frame variant, the sensing subfields of the trigger dependent common information subfield comprise at least one of: a NDP sensing/sounding subtype subfield, a number of extremely high throughput (EHT)-long training field (LTF) symbols extension subfield, a total number of spatial streams (NSS) subfield, a punctured channel information subfield, or an EHT-SIG disregard subfield.

8. The method of claim 1, wherein a reserved bit in the common information field indicates that the trigger frame is for sensing.

9. The method of claim 1, wherein the trigger response frame is a null data packet (NDP) physical layer protocol data unit (PPDU).

10. The method of claim 1, further comprising receiving an indication of a collaborative responder role, wherein the indication of a collaborative responder role is received in a sensing measurement parameters field.

11. A station (STA) configured for wireless local area network (WLAN) sensing, the STA comprising:
a receiver configured to receive a trigger frame, wherein the trigger frame comprises at least a common information field, wherein the common information field comprises at least a trigger type subfield and a trigger dependent common information subfield, wherein the trigger dependent common information subfield comprises sensing subfields, wherein the sensing subfields are based on a value of the trigger type subfield; and
a transmitter configured to send a trigger response frame, wherein a format of the trigger response frame is at least based on at least one of the sensing subfields of the trigger dependent common information subfield.

12. The STA of claim 11, wherein the trigger frame further comprises a user information field, wherein the user information field comprises a trigger dependent user information subfield, wherein the trigger dependent user information subfield comprises at least a threshold value subfield and an indication of results collection subfield.

13. The STA of claim 12, wherein information in the trigger response frame is at least based on the threshold value subfield and the indication of results collection subfield.

14. The STA of claim 11, wherein the value of the trigger type subfield indicates a ranging trigger frame variant or a null data packet (NDP) sounding poll trigger frame variant.

15. The STA of claim 14, wherein on a condition that the value of the trigger type subfield value indicates a ranging trigger frame variant, the sensing subfields of the trigger dependent common information subfield comprise at least one of: a sensing trigger subtype subfield, a measurement setup identification (MSI) subfield, a measurement instance identification (MII) subfield, or a session setup identification subfield.

16. The STA of claim 15, wherein the sensing trigger subtype subfield comprises information indicating a sensing trigger frame subvariant, wherein the sensing trigger frame subvariant comprises one of: poll, null data packet (NDP) soliciting, report, threshold based result collection, or group NDP soliciting.

17. The STA of claim 14, wherein on a condition that the value of the trigger type subfield indicates a NDP sounding poll trigger frame variant, the sensing subfields of the trigger dependent common information subfield comprise at least one of: a NDP sensing/sounding subtype subfield, a number of extremely high throughput (EHT)-long training field (LTF) symbols extension subfield, a total number of spatial streams (NSS) subfield, a punctured channel information subfield, or an EHT-SIG disregard subfield.

18. The STA of claim 11, wherein a reserved bit in the common information field indicates that the trigger frame is for sensing.

19. The STA of claim 11, wherein the trigger response frame is a null data packet (NDP) physical layer protocol data unit (PPDU).

20. The STA of claim 11, wherein the receiver is further configured to receive an indication of a collaborative responder role, wherein the indication of a collaborative responder role is received in a sensing measurement parameters field.
